(19) United States
(12) Patent Application Publication
(10) Pub. No.: US 2025/0273573 A1
(43) Pub. Date: Aug. 28, 2025

(54) INTEGRATED CIRCUIT AND METHOD OF FORMING THE SAME

(71) Applicant: TAIWAN SEMICONDUCTOR MANUFACTURING COMPANY, LTD., Hsinchu (TW)

(72) Inventors: Kuo-Nan YANG, Hsinchu (TW); Hao-Tien KAN, Hsinchu (TW); Chung-Hsing WANG, Hsinchu (TW); Yi-Kan CHENG, Hsinchu (TW)

(21) Appl. No.: 18/586,942

(22) Filed: Feb. 26, 2024

Related U.S. Application Data
(60) Provisional application No. 63/587,355, filed on Oct. 2, 2023.

(51) Int. Cl. H01L 23/532; H01L 23/522; H01L 27/02; H01L 27/06

(52) U.S. Cl. CPC H01L 23/53228; H01L 23/5226; H01L 23/53257; H10D 84/40; H10D 89/10

(57) ABSTRACT

An integrated circuit includes a first cell region including a first set of transistors having a first size, a second cell region including a second set of transistors having a second size, and a first and second set of conductors. The first and second cell region have a first height. The first and second set of transistors include a corresponding first or second active region on a first level. The first set of conductors is on a first metal layer above a front-side of a substrate and is coupled to the first or second set of transistors. The second set of conductors is on a second metal layer below a back-side of the substrate and is coupled to the first set of transistors. The first and second set of conductors are configured to supply a supply voltage or a reference supply voltage.

### PRIORITY CLAIM

This application claims the benefit of U.S. Provisional Application No. 63/587,355, filed Oct. 2, 2023, which is herein incorporated by reference in its entirety.

### BACKGROUND

The recent trend in miniaturizing integrated circuits (ICs) has resulted in smaller devices which consume less power yet provide more functionality at higher speeds. The miniaturization process has also resulted in stricter design and manufacturing specifications as well as reliability challenges. For example, as ICs have become smaller and more complex, operating voltages of these digital devices continue to decrease affecting IC performance. Various electronic design automation (EDA) tools generate, optimize and verify standard cell layout designs for integrated circuits while ensuring that the standard cell layout design and manufacturing specifications are met.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a diagram of a layout design, in accordance with some embodiments.

FIG. 1B is a diagram of a layout design, in accordance with some embodiments.

FIGS. 2A-2C are corresponding diagrams of corresponding portions of a layout design of a corresponding integrated circuit, in accordance with some embodiments.

FIGS. 3A-3G are diagrams of an integrated circuit, in accordance with some embodiments.

FIGS. 4A-4B are corresponding diagrams of an integrated circuit, in accordance with some embodiments.

FIGS. 5A-5B are corresponding diagrams of an integrated circuit, in accordance with some embodiments.

FIGS. 6A-6B are corresponding diagrams of an integrated circuit, in accordance with some embodiments.

FIGS. 7A-7B are corresponding diagrams of an integrated circuit, in accordance with some embodiments.

FIGS. 8A-8B are corresponding diagrams of an integrated circuit, in accordance with some embodiments.

FIGS. 9A-9B are corresponding diagrams of an integrated circuit, in accordance with some embodiments.

FIGS. 10A-10B are corresponding diagrams of an integrated circuit, in accordance with some embodiments.

FIG. 11A-11B are functional flow charts of corresponding methods of manufacturing an IC device, in accordance with some embodiments.

FIG. 12 is a flow chart of a method of manufacturing an integrated circuit, in accordance with some embodiments.

FIG. 13 is a flowchart of a method of generating a layout design of an integrated circuit, in accordance with some embodiments.

FIG. 14 is a schematic view of a system for designing an IC layout design and manufacturing an IC circuit, in accordance with some embodiments.

FIG. 15 is a block diagram of an IC manufacturing system, and an IC manufacturing flow associated therewith, in accordance with at least one embodiment of the present disclosure.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In accordance with some embodiments, an integrated circuit includes a first cell region. In some embodiments, the first cell region extends in a first direction. In some embodiments, the first cell region has a first height in a second direction. In some embodiments, the second direction is different from the first direction.

In some embodiments, the first cell region includes at least a first set of transistors. In some embodiments, the first set of transistors includes a first active region extending in the first direction, and is on a first level.

In some embodiments, the integrated circuit further includes a second cell region. In some embodiments, the second cell region extends in the first direction. In some embodiments, the second cell region has the first height in the second direction.

In some embodiments, the second cell region includes at least a second set of transistors. In some embodiments, the second set of transistors includes a second active region extending in the first direction, being on the first level, and being separated from the first active region in the second direction.

In some embodiments, the integrated circuit further includes a first set of conductors. In some embodiments, the first set of conductors extends in the first direction, is on a first metal layer and overlaps the first active region or the second active region. In some embodiments, the first metal layer is above a front-side of a substrate. and is referred to as a “front-side power rails or technology.”

In some embodiments, the first set of conductors is coupled to the first set of transistors or the second set of transistors. In some embodiments, the first set of conductors is configured to supply at least a supply voltage or a reference supply voltage.

In some embodiments, the integrated circuit further includes a second set of conductors. In some embodiments, the second set of conductors extends in the first direction, and is on a second metal layer. In some embodiments, the second metal layer is below a back-side of the substrate, and is referred to as a “back-side power rails or technology.”

In some embodiments, the second set of conductors is configured to supply at least the supply voltage or the reference supply voltage. In some embodiments, the second set of conductors is coupled to at least the first set of transistors.

In some embodiments, the first set of transistors have a first size. In some embodiments, the second set of transistors have a second size. In some embodiments, the second size is different from the first size.

In some embodiments, by integrated circuit including having front-side power rails and back-side power rails, the first set of transistors and the second set of transistors have different sizes resulting in a more flexible integrated circuit and corresponding design.

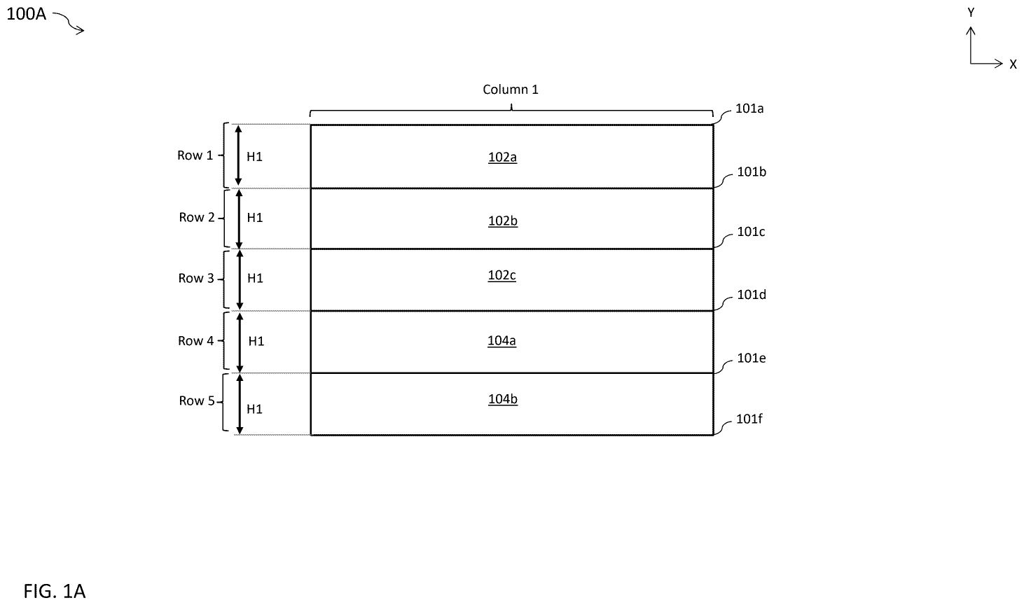

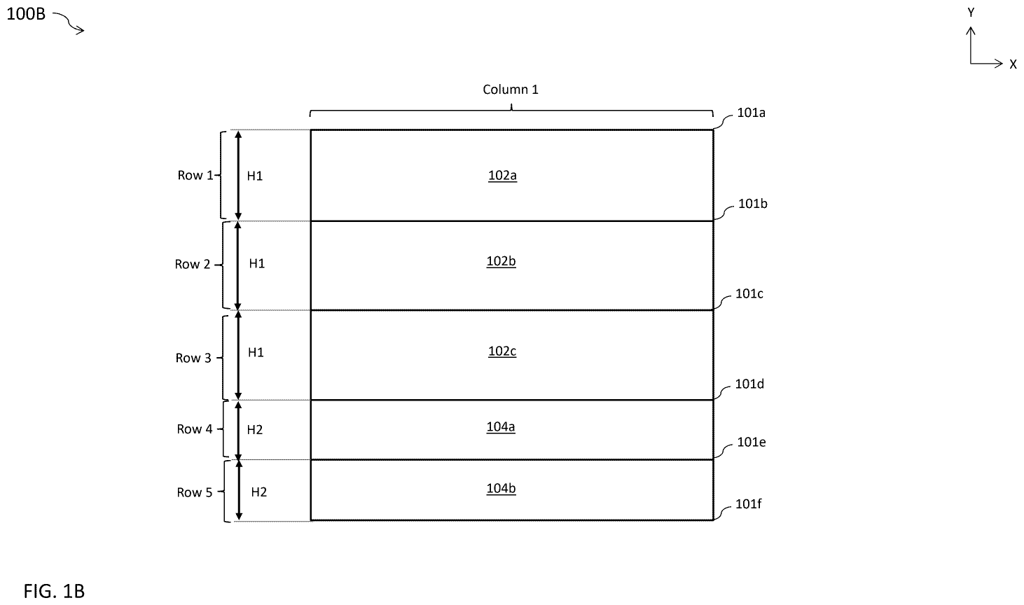

FIG. 1A is a diagram of a layout design 100A, in accordance with some embodiments.

FIG. 1B is a diagram of a layout design 100B, in accordance with some embodiments.

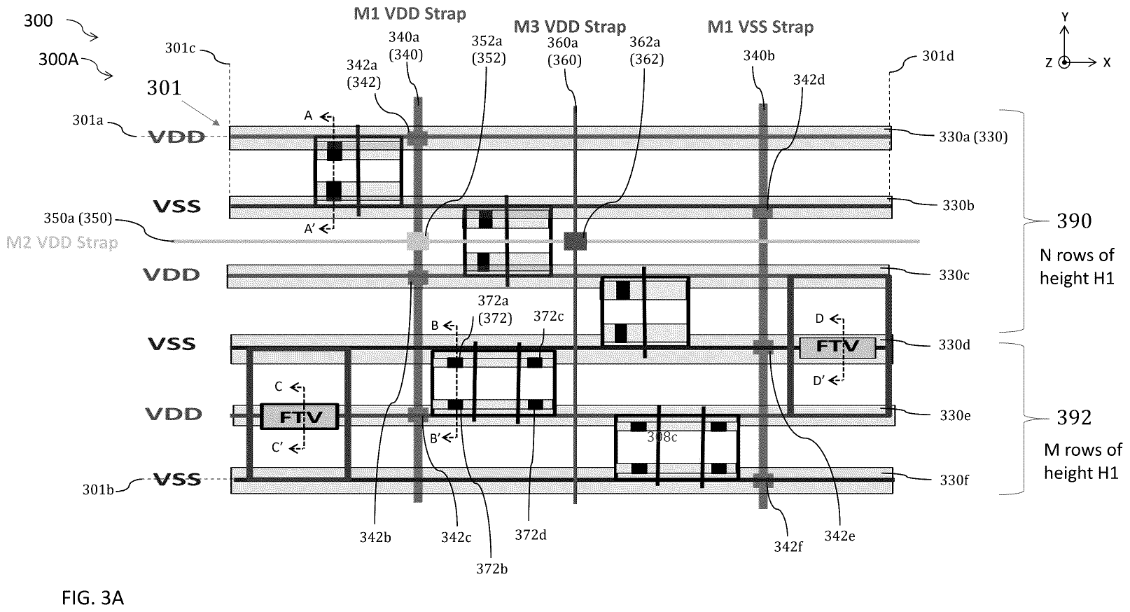

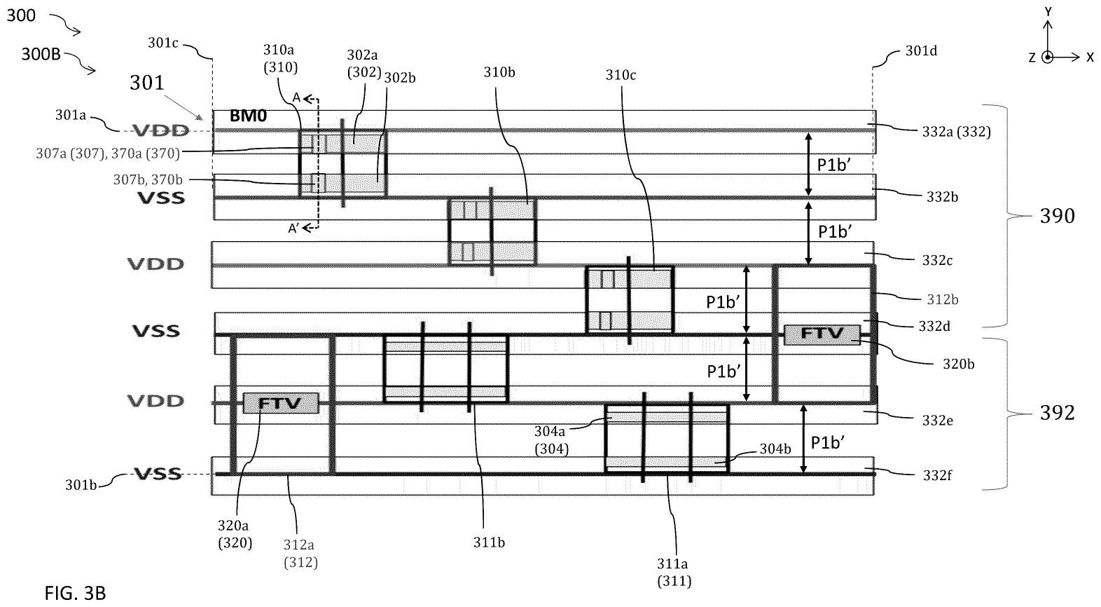

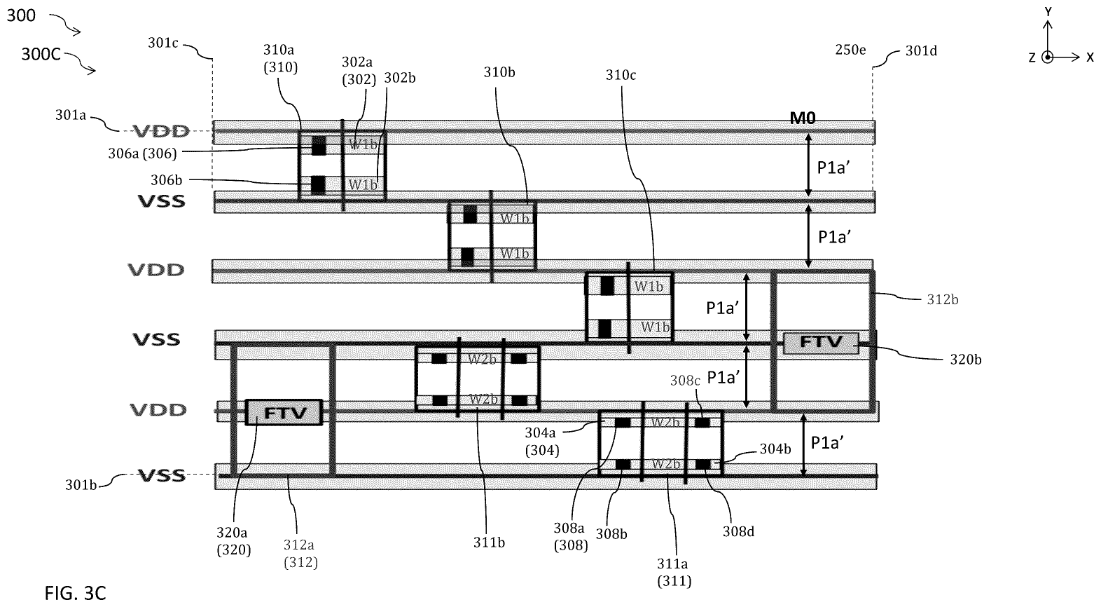

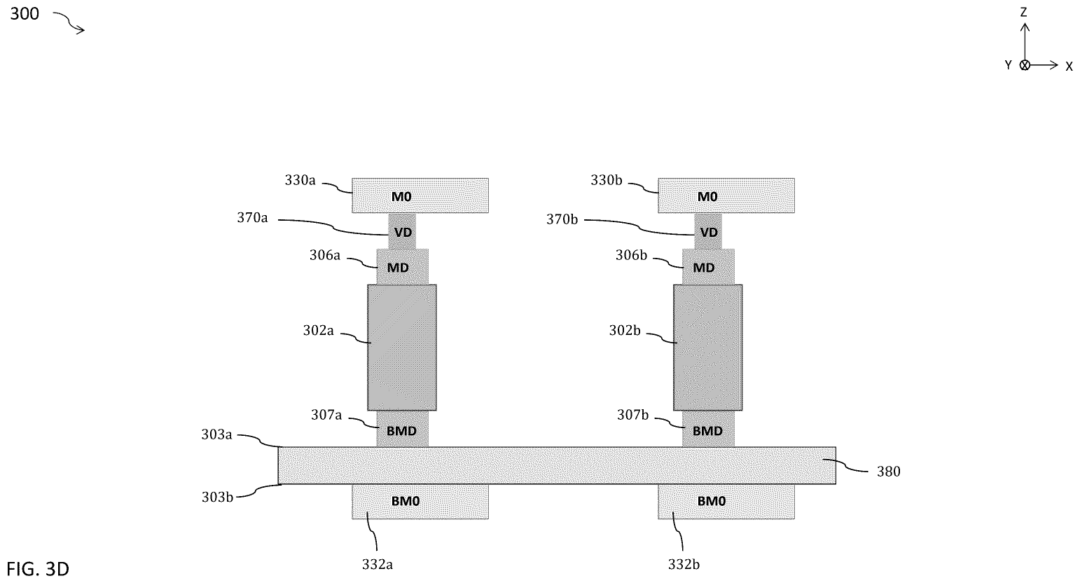

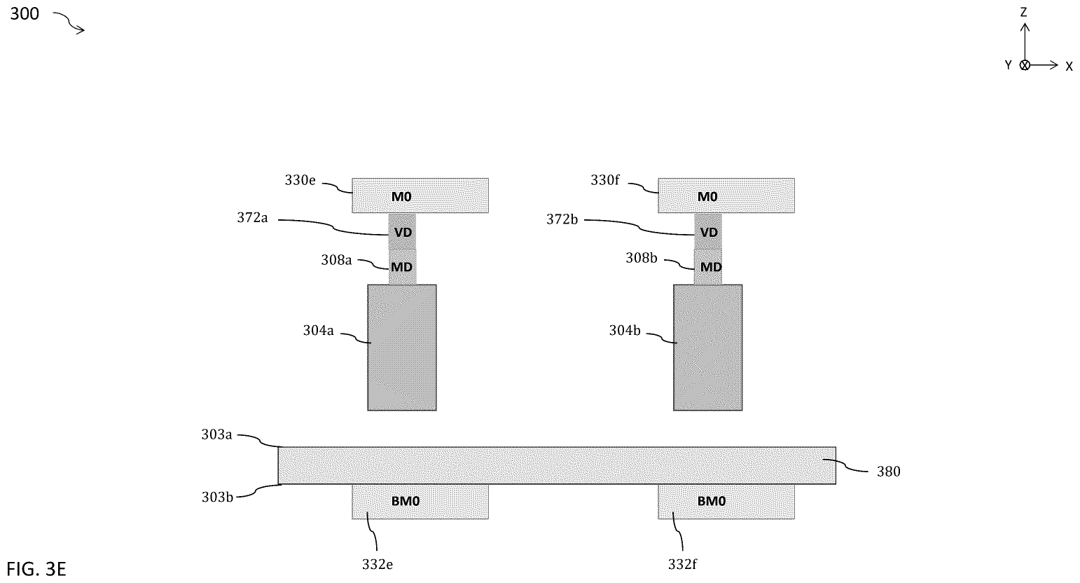

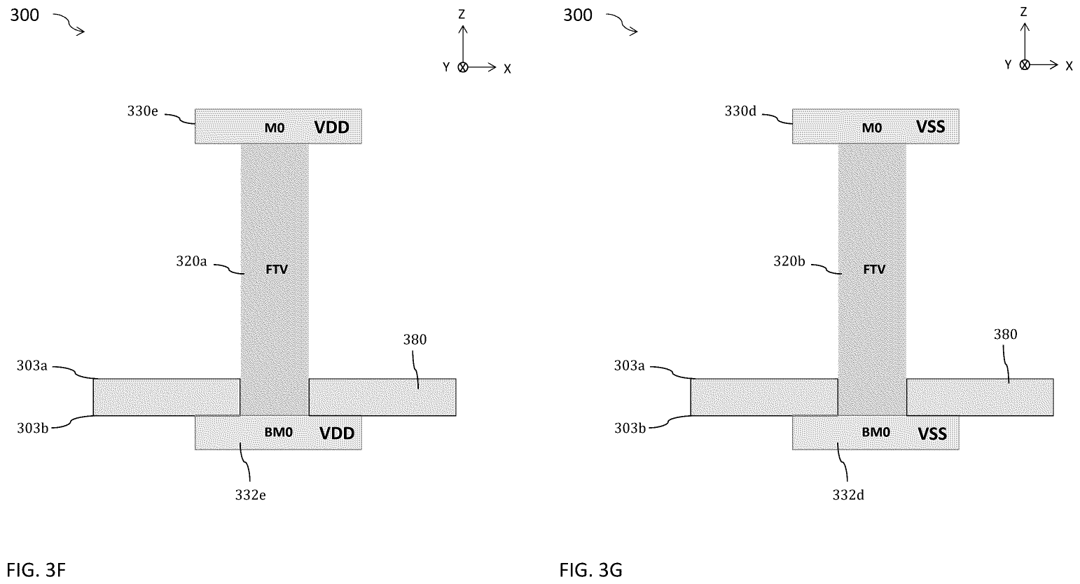

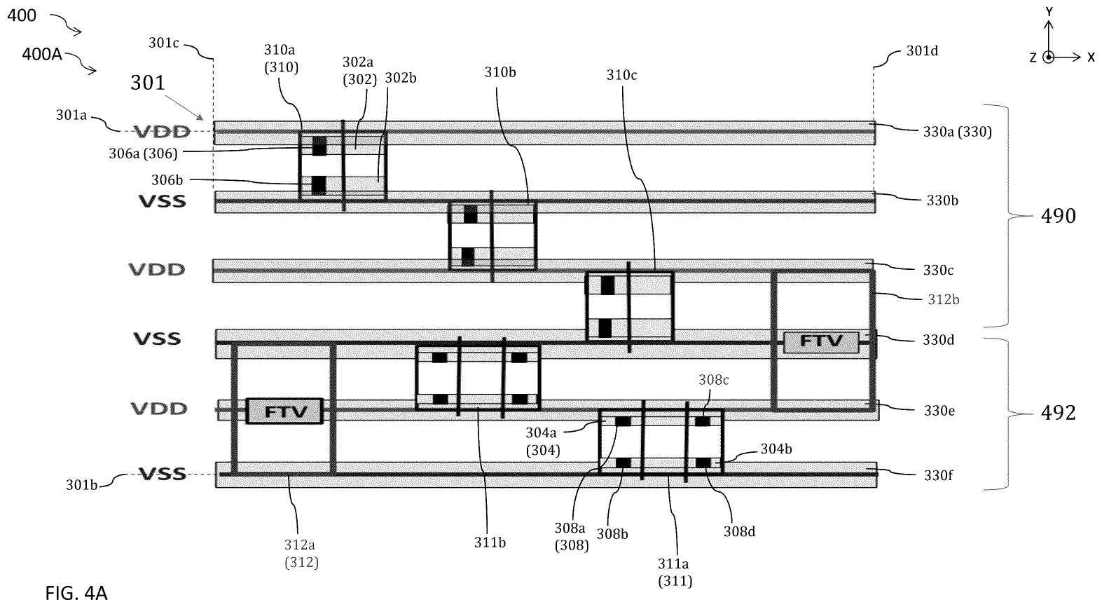

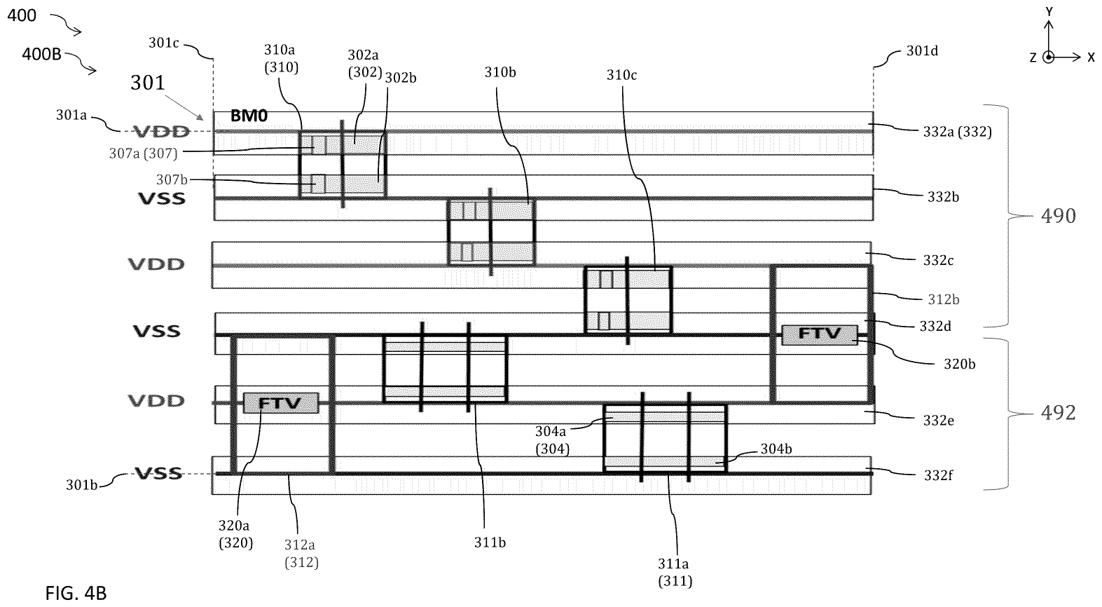

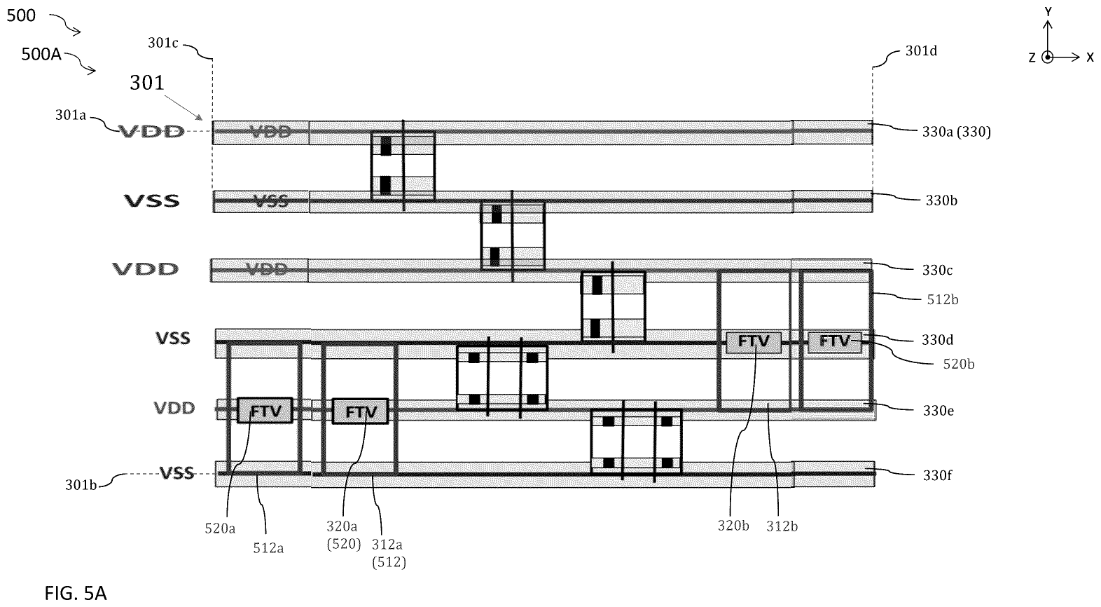

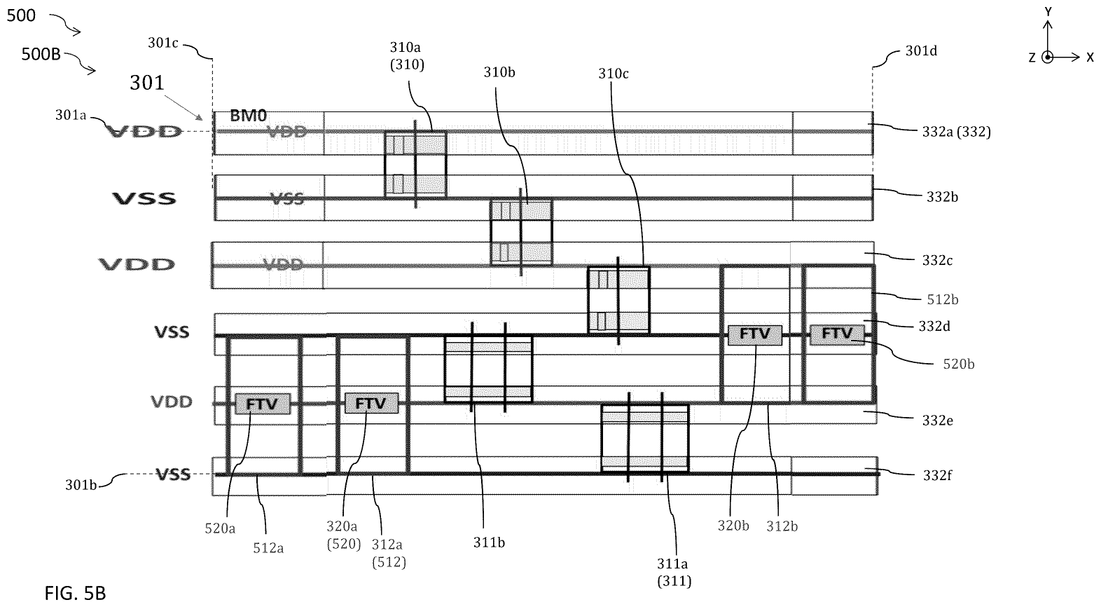

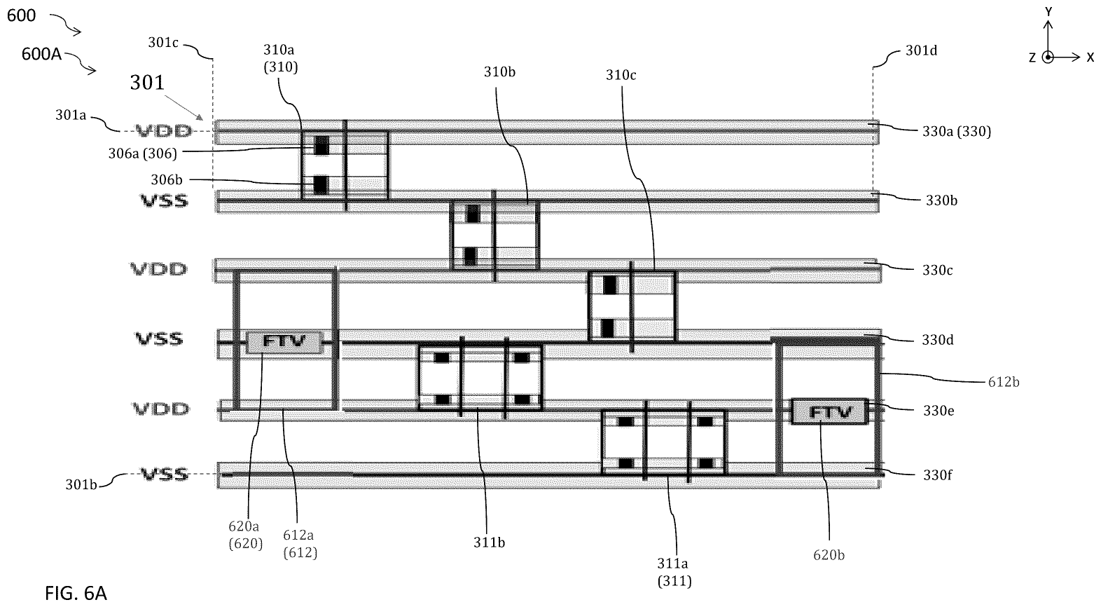

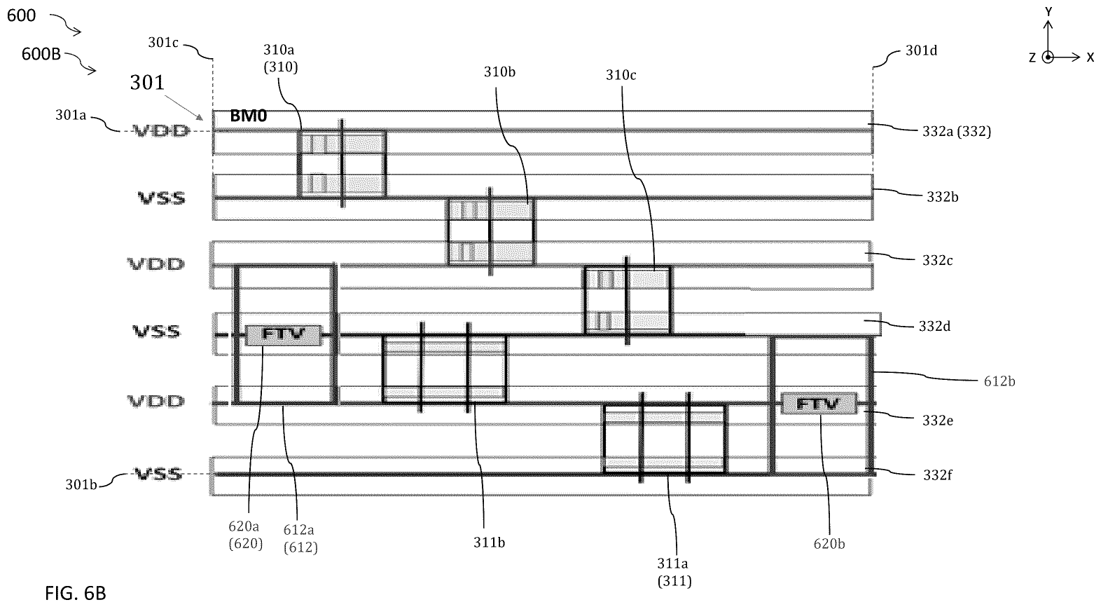

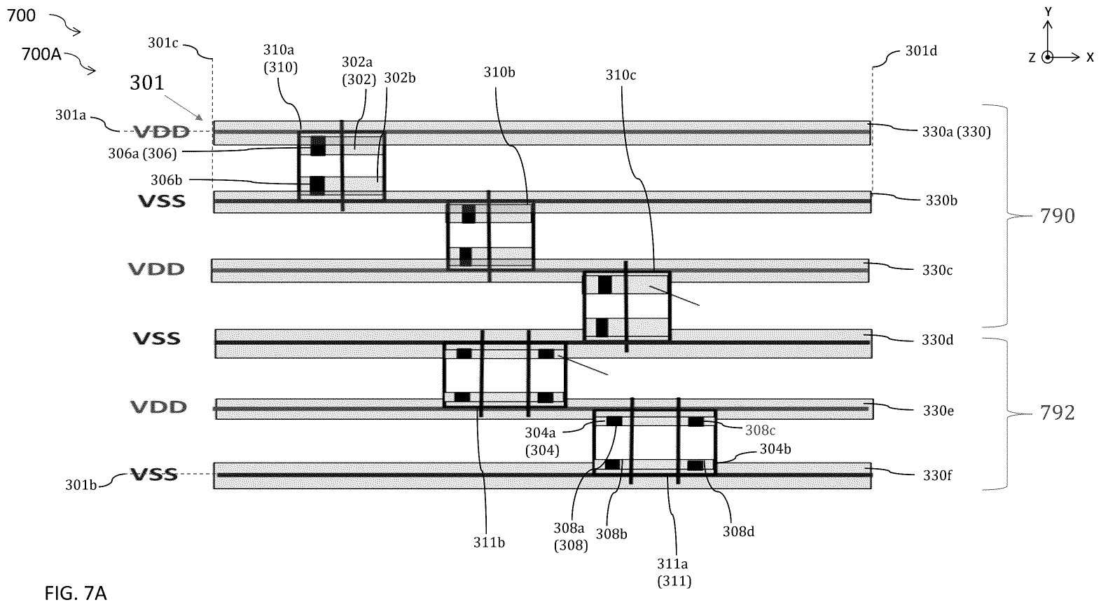

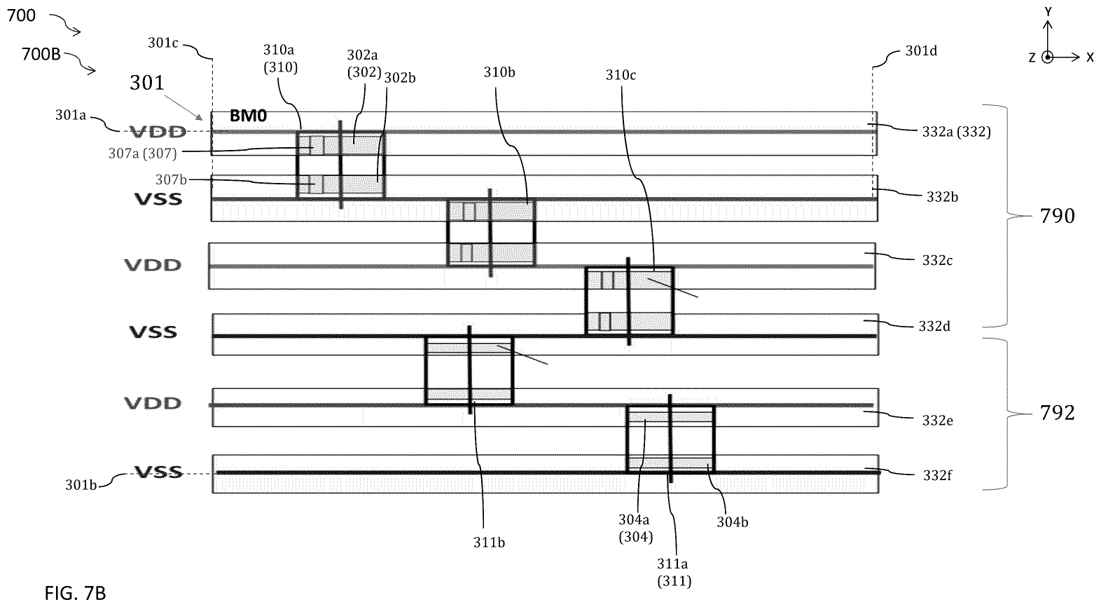

Layout design 100A is a layout diagram of an integrated circuit, such as integrated circuit 300A of FIGS. 3A-3G, integrated circuit 400 of FIGS. 4A-4B, integrated circuit 500 of FIGS. 5A-5B, integrated circuit 600 of FIGS. 6A-6B or integrated circuit 700 of FIGS. 7A-7B. Layout design 100A is usable to manufacture an integrated circuit, such as integrated circuit 300A of FIGS. 3A-3G, integrated circuit 400 of FIGS. 4A-4B, integrated circuit 500 of FIGS. 5A-5B, integrated circuit 600 of FIGS. 6A-6B or integrated circuit 700 of FIGS. 7A-7B.

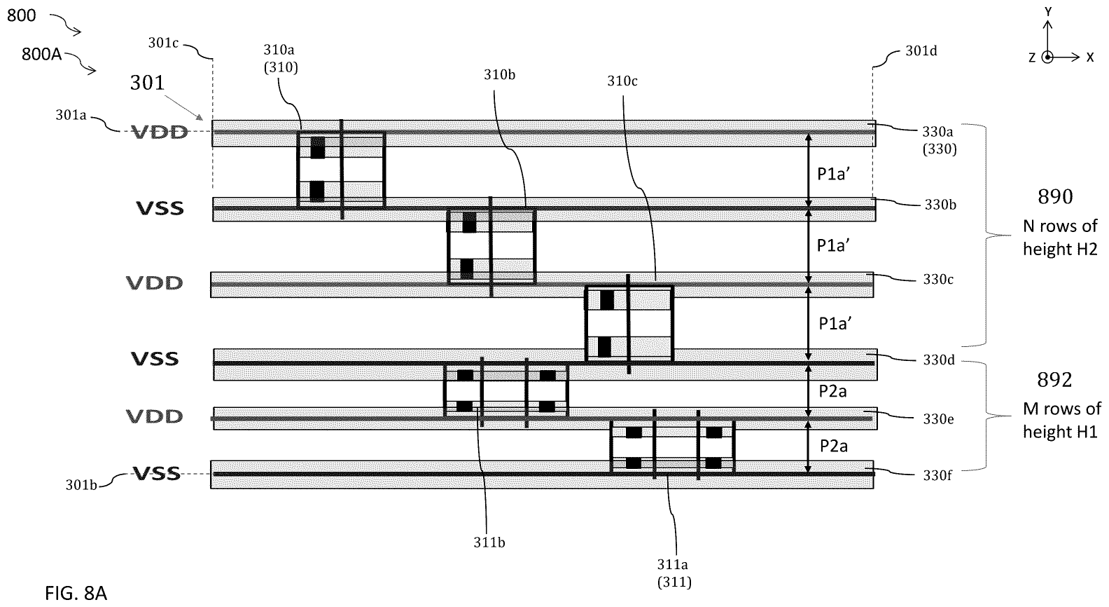

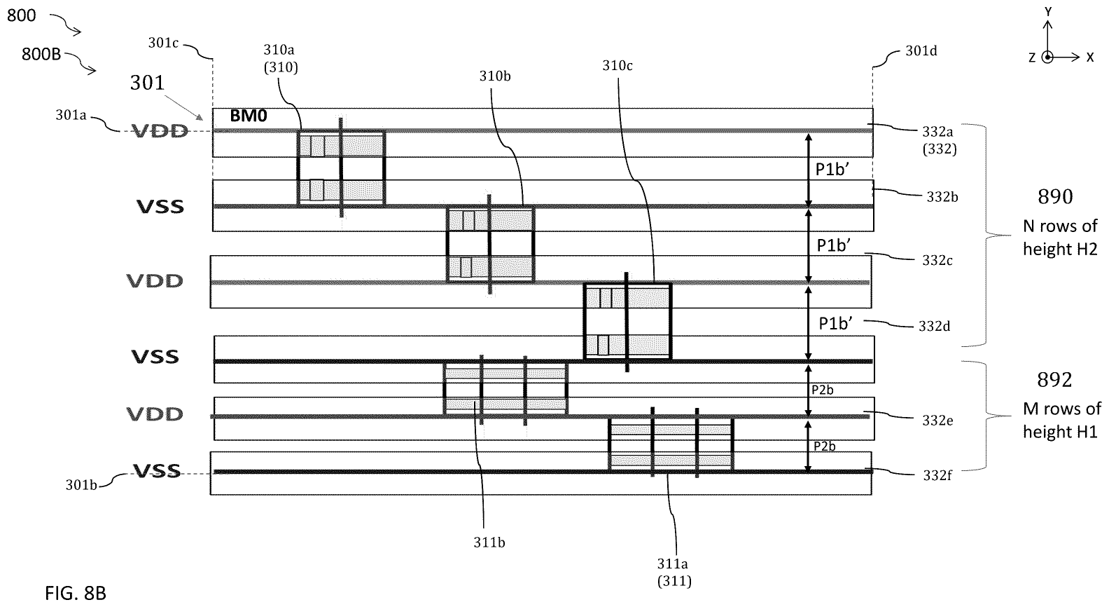

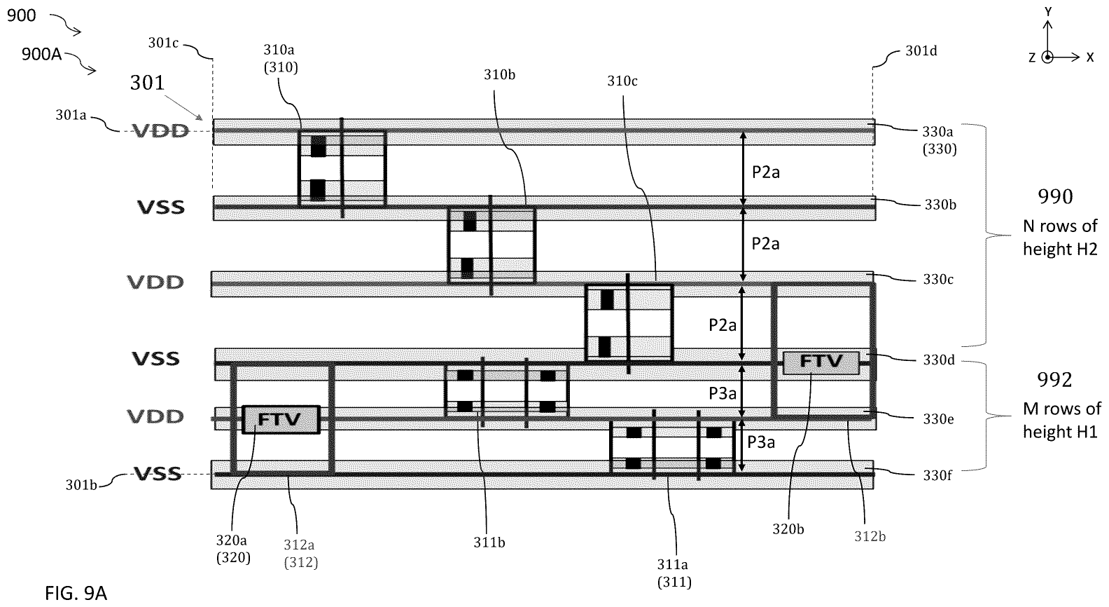

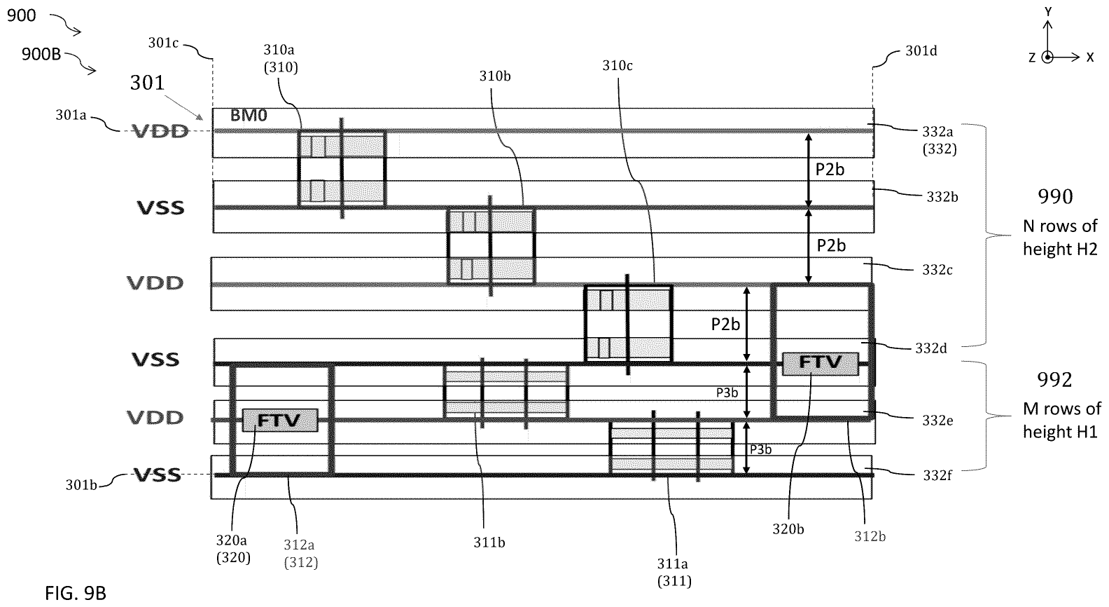

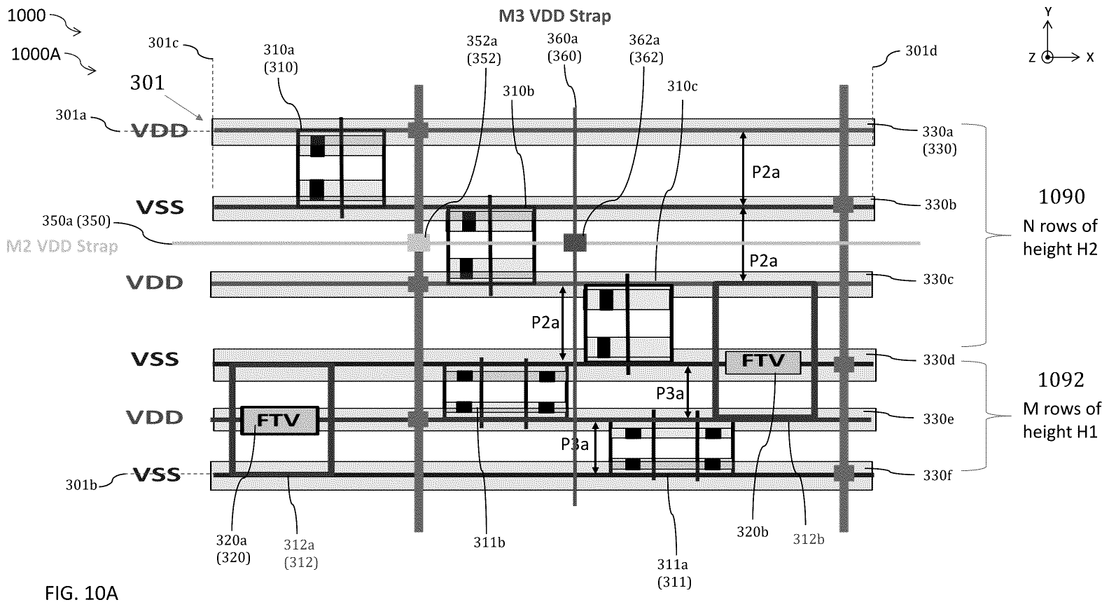

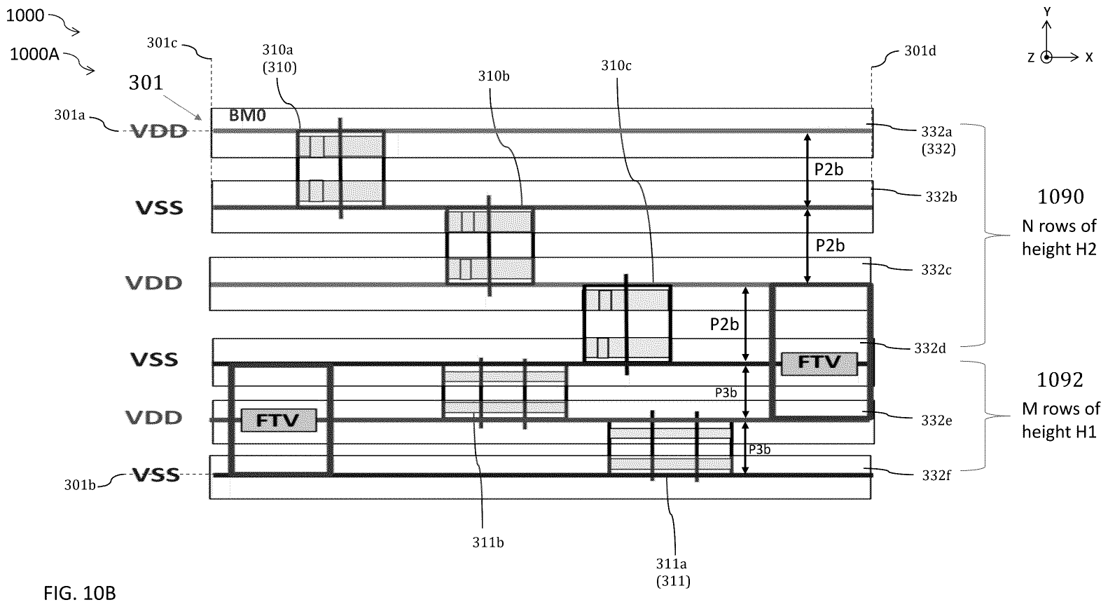

Layout design 100B is a layout diagram of an integrated circuit, such as integrated circuit 800 of FIGS. 8A-8B, integrated circuit 900 of FIGS. 9A-9B or integrated circuit 1000 of FIGS. 10A-10B. Layout design 100B is usable to manufacture an integrated circuit, such as integrated circuit 800 of FIGS. 8A-8B, integrated circuit 900 of FIGS. 9A-9B or integrated circuit 1000 of FIGS. 10A-10B.

Layout design 100A or 100B includes standard cell layout designs 102a, 102b, 102c, 104a and 104b. In some embodiments, layout design 100A or 100B includes additional elements not shown in FIG. 1A.

Each of standard cell layout designs 102a, 102b, 102c, 104a and 104b extend in at least a first direction X. Each of standard cell layout designs 102a, 102b, 102c, 104a and 104b are separated from another of standard cell layout designs 102a, 102b, 102c, 104a and 104b in a second direction Y. In some embodiments, the second direction Y is different from the first direction X.

Standard cell layout design 102a has a cell boundary 101a that extends in a first direction X. In some embodiments, standard cell layout design 102a is adjacent in the first direction along the cell boundary 101a to other standard cell layout designs (not shown for ease of illustration).

Standard cell layout design 102a is adjacent to standard cell layout design 102b in the first direction X along a cell boundary 101b. Standard cell layout design 102b is adjacent to standard cell layout design 102c in the first direction X along a cell boundary 101c. Standard cell layout design 102c is adjacent to standard cell layout design 104a in the first direction X along cell boundary 101d. Standard cell layout design 104a is adjacent to standard cell layout design 104b in the first direction X along cell boundary 101e.

Standard cell layout design 104b has a cell boundary 101e that extends in the first direction X. In some embodiments, standard cell layout design 104b is adjacent in the first direction along the cell boundary 101e to other standard cell layout designs (not shown for ease of illustration).

Other configurations or quantities of standard cell layout designs 102a, 102b, 102c, 104a and 104b are within the scope of the present disclosure. For example, layout design 100A of FIG. 1A includes one column (Column 1) and five rows (Rows 1-5) of cells (e.g., standard cell layout designs 102a, 102b, 102c, 104a and 104b). Other numbers of rows and/or columns in layout design 100A are within the scope of the present disclosure. For example, in some embodiments, layout design 100A includes at least an additional column of cells, similar to column 1, and being adjacent to column 1. For example, in some embodiments, layout design 100A includes at least an additional row of cells, similar to row 2, adjacent to row 1 along cell boundary 101a. For example, in some embodiments, layout design 100A includes at least an additional row of cells, similar to row 4, adjacent to row 1 along cell boundary 101a. For example, in some embodiments, layout design 100A includes at least an additional row of cells, similar to row 4, adjacent to row 5 along corresponding cell boundary 101f. For example, in some embodiments, layout design 100A includes at least an additional row of cells, similar to row 1, adjacent to row 5 along corresponding cell boundary 101f. In some embodiments, standard cell layout design 102a, 102b and 102c alternate with standard cell layout design 104a and 104b in the second direction Y.

In layout design 100A of FIG. 1A, each of standard cell layout design 102a, 102b, 102c, 104a or 104b has a height H1 in the second direction Y.

At least one of standard cell layout design 102a, 102b or 102c is a same layout design as another of standard cell layout design 102a, 102b or 102c. In some embodiments, at least one of standard cell layout design 102a, 102b or 102c is a different layout design from another of standard cell layout design 102a, 102b or 102c.

At least one of standard cell layout design 104a or 104b is a same layout design as another of standard cell layout design 104a or 104b. In some embodiments, at least one of standard cell layout design 104a or 104b is a different layout design from another of standard cell layout design 104a or 104b.

In some embodiments, at least one of standard cell layout design 102a, 102b or 102c is a same layout design as one of standard cell layout design 104a or 104b. In some embodiments, at least one of standard cell layout design 102a, 102b or 102c is a different layout design as one of standard cell layout design 104a or 104b.

In some embodiments, standard cell layout designs 102a, 102b and 102c are useable to manufacture at least one of a portion 390 of integrated circuit 300 (FIGS. 3A-3G), a portion 490 of integrated circuit 400 (FIGS. 4A-4B), a portion 590 of integrated circuit 500 (FIGS. 5A-5B), a portion 690 of integrated circuit 600 (FIGS. 6A-6B) or a portion 790 of integrated circuit 700 (FIGS. 7A-7B).

In some embodiments, standard cell layout designs 104a and 104b are useable to manufacture at least one of a portion 392 of integrated circuit 300 (FIGS. 3A-3G), a portion 492 of integrated circuit 400 (FIGS. 4A-4B), a portion 592 of integrated circuit 500 (FIGS. 5A-5B), a portion 692 of integrated circuit 600 (FIGS. 6A-6B) or a portion 792 of integrated circuit 700 (FIGS. 7A-7B).

In some embodiments, one or more of standard cell layout designs 102a, 102b, 102c, 104a or 104b is a layout design of a logic gate cell. In some embodiments, a logic gate cell includes an AND, OR, NAND, NOR, XOR, INV, AND-OR-Invert (AOI), OR-AND-Invert (OAI), MUX, Flip-flop, BUFF, Latch, delay, or clock cells. In some embodiments, one or more of standard cell layout designs 102a, 102b, 102c, 104a or 104b is a layout design of a memory cell. In some embodiments, a memory cell includes a static random access memory (SRAM), a dynamic RAM (DRAM), a resistive RAM (RRAM), a magnetoresistive RAM (MRAM) or read only memory (ROM). In some embodiments, one or more of standard cell layout designs 102a, 102b, 102c, 104a or 104b includes layout designs of one or more active or passive elements. Examples of active elements include, but are not limited to, transistors and diodes. Examples of transistors include, but are not limited to, metal oxide semiconductor field effect transistors (MOSFET), complementary metal oxide semiconductor (CMOS) transistors, bipolar junction transistors (BJT), high voltage transistors, high frequency transistors, p-channel and/or n-channel field effect transistors (PFETs/NFETs), etc.), FinFETs, nanosheet transistors, nanowire transistors, complementary FET (CFET) transistors and planar MOS transistors with raised source/drain. Examples of passive elements include, but are not limited to, capacitors, inductors, fuses, and resistors.

Other configurations or quantities of layout design 100A are within the scope of the present disclosure.

FIG. 1B is a diagram of a layout design 100B, in accordance with some embodiments.

Layout design 100B is a variation of layout design 100A of FIG. 1A, and similar detailed description is therefore omitted. In comparison with layout design 100A of FIG. 1A, layout design 100B has a hybrid row design that includes at least two rows with different heights, and similar detailed description is therefore omitted. For example, standard cell layout designs 104a and 104b of layout design 100B have a different height than standard cell layout designs 102a, 102b or 102c of layout design 100B, and similar detailed description is therefore omitted.

Layout design 100B is a layout diagram of an integrated circuit, such as integrated circuit 800 of FIGS. 8A-8B, integrated circuit 900 of FIGS. 9A-9B or integrated circuit 1000 of FIGS. 10A-10B. Layout design 100B is usable to manufacture an integrated circuit, such as integrated circuit 800 of FIGS. 8A-8B, integrated circuit 900 of FIGS. 9A-9B or integrated circuit 1000 of FIGS. 10A-10B.

Layout design 100B includes standard cell layout designs 102a, 102b, 102c, 104a and 104b. In some embodiments, layout design 100B includes additional elements not shown in FIG. 1B.

In layout design 100B of FIG. 1B, each of standard cell layout design 102a, 102b or 102c, has a height H1 in the second direction Y, and each of standard cell layout design 104a or 104b has a height H2 in the second direction Y. Height H2 is different from height H1.

In some embodiments, standard cell layout designs 102a, 102b and 102c are useable to manufacture at least one of a portion 890 of integrated circuit 800 (FIGS. 8A-8B), a portion 990 of integrated circuit 900 (FIGS. 9A-9B), or a portion 1090 of integrated circuit 1000 (FIGS. 10A-10B).

In some embodiments, standard cell layout designs 104a and 104b are useable to manufacture at least one of a portion 892 of integrated circuit 800 (FIGS. 8A-8B), a portion 992 of integrated circuit 900 (FIGS. 9A-9B), or a portion 1092 of integrated circuit 1000 (FIGS. 10A-10B).

Other configurations or quantities of layout design 100B are within the scope of the present disclosure.

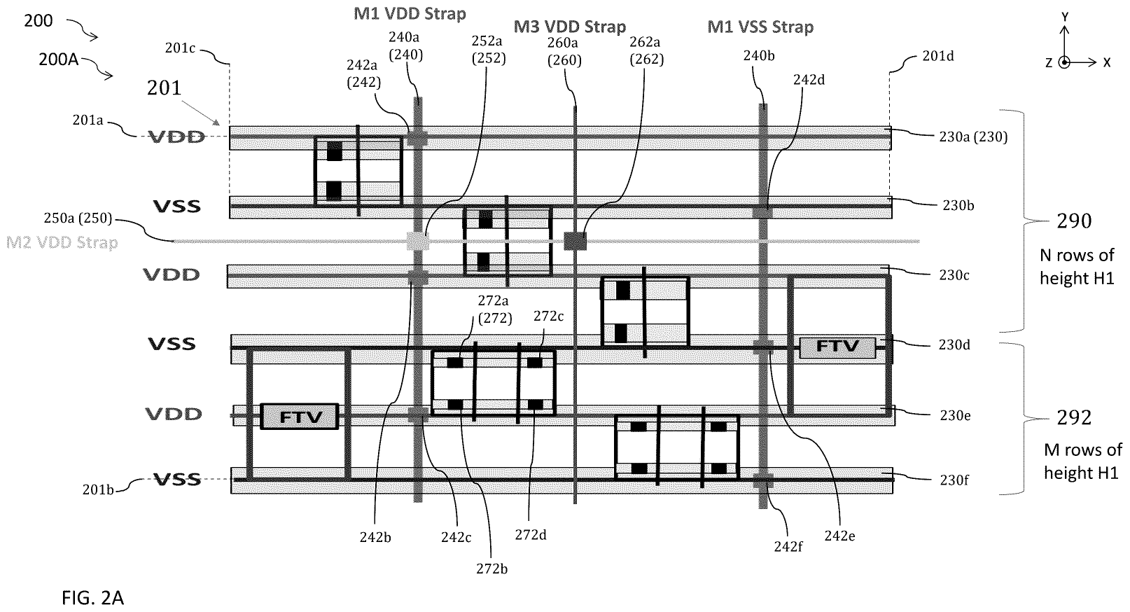

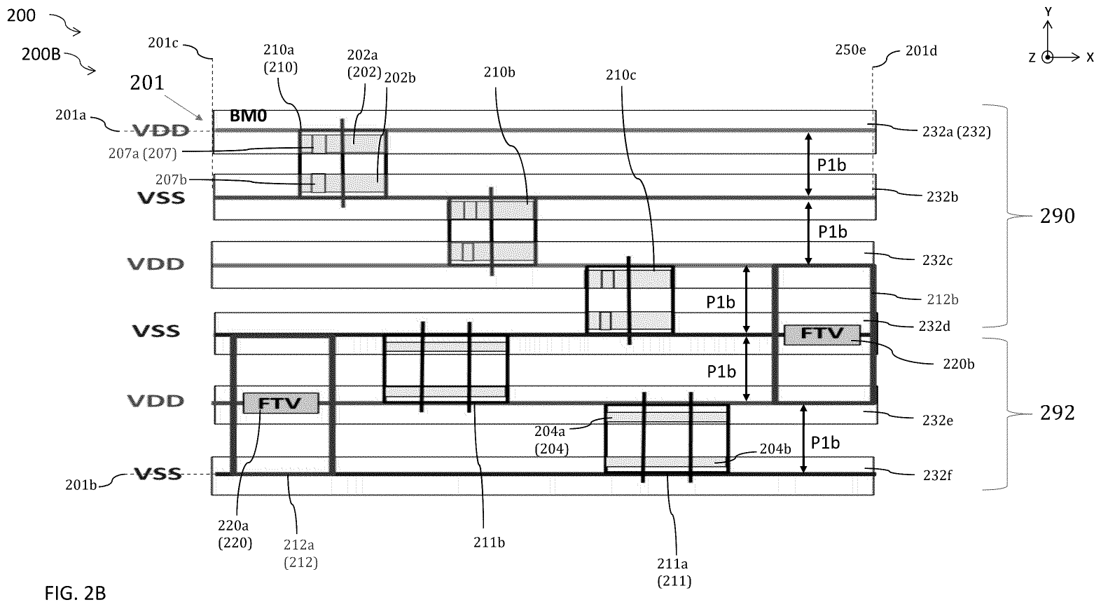

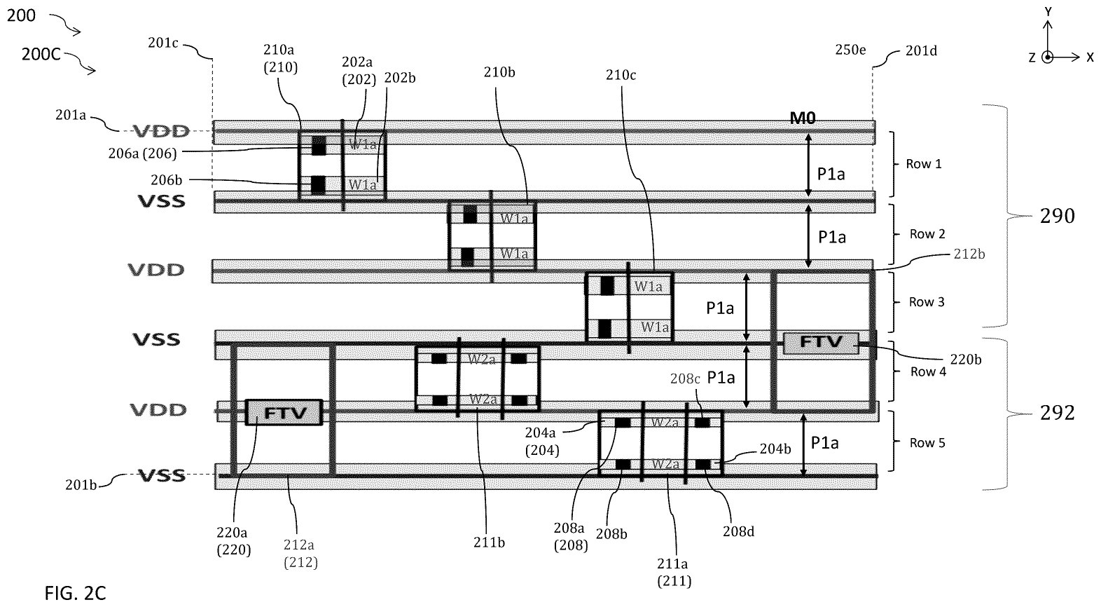

FIGS. 2A-2C are diagrams of layout designs, in accordance with some embodiments.

FIGS. 2A-2C are corresponding diagrams of corresponding portions 200A-200C of a layout design 200 of a corresponding integrated circuit 300, in accordance with some embodiments.

Layout design 200 is layout design 100A of FIG. 1A, and similar detailed description is therefore omitted. Layout design 200 is a layout of an integrated circuit 300 of FIGS. 3A-3G.

Portion 200A includes one or more features of layout design 200 of an active level or an oxide diffusion (OD) level, a metal over diffusion (MD) level, a metal 0 (M0) level, a metal 1 (M1), a metal 2 (M2), a metal 3 (M3), a via over metal 0 (V0) level, a via over metal 1 (V1) level, a via over metal 2 (V2) level and a feed-through via (FTV) level. In some embodiments, the FTV level connects a front-side and a back-side of layout design 200. In some embodiments, the FTV level connects one or more elements on a front-side 303a of integrated circuit 300 with one or more elements on a back-side 303b of integrated circuit 300.

Portion 200B includes one or more features of layout design 200 of the OD level, a backside metal over diffusion (BMD) level, a backside metal 0 (BM0), and the FTV level.

Portion 200C includes one or more features of layout design 200 of the OD level, the MD level, the M0 level and the FTV level.

FIGS. 2A-2C are corresponding diagrams of corresponding portions 200A-200C of layout design 200, simplified for ease of illustration.

For ease of illustration, some of the labeled elements of one or more of FIGS. 1-10B are not labelled in one or more of FIGS. 1-10B. In some embodiments, layout design 200 includes additional elements not shown in FIGS. 2A-2C.

Layout design 200 includes one or more features of the OD level, the MD level, the M0 level, the M1 level, the M2 level, the M3 level, the V0 level, the V1 level, the V2 level, the FTV level, the BMD level and the BM0 level. In some embodiments, at least layout design 200, or integrated circuit 300, 400, 500, 600, 700, 800, 900 or 1000 includes additional elements not shown in FIG. 2A-2C, 3A-3G, 4A-4B, 5A-5B, 6A-6B, 7A-7B, 8A-8B, 9A-9B or 10A-10B.

Layout design 200 is usable to manufacture integrated circuit 300 of FIGS. 3A-3G.

Portion 200A is a layout of portion 300A of integrated circuit 300 of FIG. 3A, portion 200B is a layout of portion 300B of integrated circuit 300 of FIG. 3B, and portion 200C is a layout of portion 300C of integrated circuit 300 of FIG. 3C, and similar detailed description is omitted for brevity. In some embodiments, at least one of portion 200A or 200C is referred to as a front-side view of layout design 200. In some embodiments, portion 200B is referred to as a back-side view of layout design 200.

In some embodiments, layout design 200 is a cell 201. The cell 201 has cell boundaries 201a and 201b that extend in the first direction X, and cell boundaries 201c and 201d that extend in the second direction Y.

In some embodiments, cell 201 corresponds to layout design 100A of FIG. 1A, and similar detailed description is omitted for brevity. In some embodiments, cell boundary 201a or 201b is corresponding cell boundary 101a or 101f of layout design 100A of FIG. 1A, and similar detailed description is omitted for brevity.

In some embodiments, at least one of the first direction X, the second direction Y or a third direction Z is different from another of the first direction X, the second direction Y or the third direction Z. In some embodiments, layout design 200 abuts other cell layout designs (not shown) along cell boundaries 201c and 201d. In some embodiments, layout design 200 abuts other cell layout designs (not shown) along cell boundaries 201a and 201b that extend in the first direction X. In some embodiments, layout design 200 is a single height standard cell. In some embodiments, cell 201 is useable to manufacture a cell 301.

In some embodiments, cell 201 is a standard cell, and layout design 200 corresponds to a layout of a standard cell defined by cell boundaries 201a, 201b, 201c and 201d. In some embodiments, a cell 201 is a predefined portion of layout design 200 including one or more transistors and electrical connections configured to perform one or more circuit functions. In some embodiments, cell 201 is bounded by cell boundaries 201a, 201b, 201c and 201d, and thus corresponds to a region of functional circuit components or devices that are part of a standard cell.

Layout design 200 includes a portion 290 and a portion 292.

In some embodiments, portion 290 is standard cell layout designs 102a, 102b and 102c of layout design 100A of FIG. 1A, and similar detailed description is omitted for brevity. In some embodiments, portion 292 is standard cell layout designs 104a and 104b of layout design 100A of FIG. 1A, and similar detailed description is omitted for brevity.

Layout design 200 includes at least one of cell layout patterns 210a, 210b or 210c (collectively referred to as a “set of cell layouts 210”) extending in the first direction X. Embodiments of the present disclosure use the term “layout pattern” which is hereinafter also referred to as “patterns” in the remainder of the present disclosure for brevity.

The set of cell layouts 210 is usable to manufacture a corresponding set of cells 310 of integrated circuit 300, 400, 500, 600, 700, 800, 900 or 1000. In some embodiments, cell layout pattern 210a, 210b or 210c is usable to manufacture corresponding cell 310a, 310b or 310c of the set of cells 310 of integrated circuit 300, 400, 500, 600, 700, 800, 900 or 1000.

Each cell layout 210a, 210b or 210c is located within corresponding row 1, 2 or 3 of layout design 200. Each of row 1, 2, 3, 4, and 5 is corresponding row 1, 2, 3, 4, and 5 of layout design 100A or 100B, and similar detailed description is omitted for brevity.

For ease of illustration, layout design 200 shows a single cell layout 210a, 210b or 210c positioned within corresponding row 1, 2 or 3 of layout design 200. In some embodiments, one or more rows of the set of cell layouts 210 includes one or more additional cell layouts in the corresponding row 1, 2 or 3 of layout design 200.

Layout design 200 further includes at least one of cell layouts 211a or 211b (collectively referred to as a “set of cell layouts 211”) extending in the first direction X.

The set of cell layouts 211 is usable to manufacture a corresponding set of cells 311 of integrated circuit 300, 400, 500, 600, 700, 800, 900 or 1000. In some embodiments, cell layout pattern 211a or 211b is usable to manufacture corresponding cell 310a or 311b of the set of cells 311 of integrated circuit 300, 400, 500, 600, 700, 800, 900 or 1000.

Each cell layout 211a or 211b is located within corresponding row 4 or 5 of layout design 200.

For ease of illustration, layout design 200 shows a single cell layout 211a or 211b positioned within corresponding row 4 or 5 of layout design 200. In some embodiments, one or more rows of the set of cell layouts 211 includes one or more additional cell layouts in the corresponding row 4 or 5 of layout design 200.

Each cell layout of the set of cell layouts 210 includes at least one of active region pattern 202a or 202b (collectively referred to as a “set of active region patterns 202”) extending in the first direction X. Each active region pattern of the set of active region patterns 202 is separated from one another in the second direction Y.

Each cell layout of the set of cell layouts 211 includes at least one of active region pattern 204a or 204b (collectively referred to as a “set of active region patterns 204”) extending in the first direction X. Each active region pattern of the set of active region patterns 204 is separated from one another in the second direction Y.

The set of active region patterns 202 is usable to manufacture a corresponding set of active regions 302 of integrated circuit 300, 400, 500, 600, 700, 800, 900 or 1000. The set of active region patterns 204 is usable to manufacture a corresponding set of active regions 304 of integrated circuit 300, 400, 500, 600, 700, 800, 900 or 1000.

In some embodiments, at least one of the set of active regions 302 or 304 are located on a front-side 303a of integrated circuit 300, 400, 500, 600, 700, 800, 900 or 1000. In some embodiments, at least one of the set of active regions 302 or 304 corresponds to source and drain regions of one or more complementary FET (CFET) transistors. In some embodiments, at least one of the set of active regions 302 or 304 correspond to source and drain regions of one or more nanosheet transistors or nanowire transistors. In some embodiments, at least one of the set of active regions 302 or 304 corresponds to source and drain regions of one or more finFET transistors. In some embodiments, at least one of the set of active regions 302 or 304 corresponds to source and drain regions of one or more planar transistors. Other transistor types are within the scope of the present disclosure.

In some embodiments, active region pattern 202a or 202b is usable to manufacture corresponding active region 302a or 302b of the set of active regions 302 of integrated circuit 300, 400, 500, 600, 700, 800, 900 or 1000. In some embodiments, active region pattern 204a or 204b is usable to manufacture corresponding active region 304a or 304b of the set of active regions 304 of integrated circuit 300, 400, 500, 600, 700, 800, 900 or 1000.

In some embodiments, the set of active region patterns 202 and 204 are referred to as an oxide diffusion (OD) region which defines the source or drain diffusion regions of at least integrated circuit 300, 400, 500, 600, 700, 800, 900 or 1000 or layout design 200.

In some embodiments, at least one of active region pattern 202a or 204a is usable to manufacture source and drain regions of P-type transistors of integrated circuits 300, 400, 500, 600, 700, 800, 900 or 1000, and at least one of active region pattern 202b or 204b is usable to manufacture source and drain regions of N-type transistors of integrated circuits 300, 400, 500, 600, 700, 800, 900 or 1000.

In some embodiments, at least one of active region pattern 202a or 204a is usable to manufacture source and drain regions of N-type transistors of integrated circuits 300, 400, 500, 600, 700, 800, 900 or 1000, and at least one of active region pattern 202b or 204b is usable to manufacture source and drain regions of P-type transistors of integrated circuits 300, 400, 500, 600, 700, 800, 900 or 1000.

In some embodiments, the set of active region patterns 202 or 204 is located on a first layout level. In some embodiments, the first layout level corresponds to an active level or an OD level of one or more of layout design 200 or integrated circuits 300, 400, 500, 600, 700, 800, 900 or 1000. In some embodiments, the OD level is above the BM0 level.

Active region layout patterns 202a and 202b each have a width W1a in the second direction Y. In some embodiments, the width W1a is referred to as a first size.

Active region layout patterns 204a and 204b each have a width W2a in the second direction Y. In some embodiments, the width W2a is referred to as a second size.

In some embodiments, an increase in the width W1a causes the corresponding speed and driving strength of the corresponding transistor(s) manufactured by the corresponding active region pattern 202a or 202b to increase. In some embodiments, a decrease in the width W1a causes the corresponding speed and driving strength of the corresponding transistor(s) manufactured by the corresponding active region pattern 202a or 202b to decrease.

In some embodiments, an increase in the width W2a causes the corresponding speed and driving strength of the corresponding transistor(s) manufactured by the corresponding active region pattern 204a or 204b to increase. In some embodiments, a decrease in the width W2a causes the corresponding speed and driving strength of the corresponding transistor(s) manufactured by the corresponding active region pattern 204a or 204b to decrease.

In some embodiments, the width W1a is greater than the width W2a. In these embodiments, the corresponding speed and driving strength of the corresponding transistor(s) manufactured by the corresponding active region pattern 202a or 202b is greater than the corresponding speed and driving strength of the corresponding transistor(s) manufactured by the corresponding active region pattern 204a or 204b, and the set of active region patterns 202 are referred to as “large devices” and the set of active region patterns 204 are referred to as “small devices.”

Other configurations, arrangements on other layout levels or quantities of patterns in the set of active region patterns 202 or 204 are within the scope of the present disclosure.

Each cell layout of the set of cell layouts 210 further includes one or more contact patterns 206a or 206b (collectively referred to as a “set of contact patterns 206”) extending in the second direction Y.

Each of the contact patterns of the set of contact patterns 206 is separated from an adjacent contact pattern of the set of contact patterns 206 in at least the first direction X or the second direction Y.

The set of contact patterns 206 is usable to manufacture a corresponding set of contacts 306 of integrated circuit 300, 400, 500, 600, 700, 800, 900 or 1000.

In some embodiments, contact pattern 206a or 206b of the set of contact patterns 206 is usable to manufacture corresponding contact 306a or 306b of the set of contact patterns 306. In some embodiments, the set of contact patterns 206 is also referred to as a set of metal over diffusion (MD) patterns.

In some embodiments, at least one of contact pattern 206a or 206b of the set of contact patterns 206 is usable to manufacture source or drain terminals of one of the N-type or P-type transistors of integrated circuit 300, 400, 500, 600, 700, 800, 900 or 1000.

In some embodiments, contact pattern 206a is usable to manufacture source terminals of a P-type or N-type transistor. In some embodiments, contact pattern 206a is usable to manufacture drain terminals of a P-type or N-type transistor.

In some embodiments, contact pattern 206b is usable to manufacture source terminals of the P-type or N-type transistor. In some embodiments, contact pattern 206b is usable to manufacture drain terminals of the P-type or N-type transistor.

In some embodiments, the set of contact patterns 206 overlap the set of active region patterns 202. The set of contact patterns 206 is located on a second layout level. In some embodiments, the second layout level corresponds to the contact level or an MD level of one or more of layout design 200 or integrated circuits 300, 400, 500, 600, 700, 800, 900 or 1000. In some embodiments, the second layout level is different from the first layout level.

Other configurations, arrangements on other layout levels or quantities of patterns in the set of contact patterns 206 are within the scope of the present disclosure.

Each cell layout of the set of cell layouts 210 further includes one or more contact patterns 207a or 207b (collectively referred to as a “set of contact patterns 207”) extending in the second direction Y.

Each of the contact patterns of the set of contact patterns 207 is separated from an adjacent contact pattern of the set of contact patterns 207 in at least the first direction X or the second direction Y.

The set of contact patterns 207 is usable to manufacture a corresponding set of contacts 307 of integrated circuit 300, 400, 500, 600, 700, 800, 900 or 1000.

In some embodiments, contact pattern 207a or 207b of the set of contact patterns 207 is usable to manufacture corresponding contact 307a or 307b of the set of contact patterns 307. In some embodiments, the set of contact patterns 207 is also referred to as a set of back-side metal over diffusion (BMD) patterns.

In some embodiments, at least one of contact pattern 207a or 207b of the set of contact patterns 207 is usable to manufacture source or drain terminals of one of the N-type or P-type transistors of integrated circuit 300, 400, 500, 600, 700, 800, 900 or 1000.

In some embodiments, contact pattern 207a is usable to manufacture source terminals of a P-type or N-type transistor. In some embodiments, contact pattern 207a is usable to manufacture drain terminals of a P-type or N-type transistor.

In some embodiments, contact pattern 207b is usable to manufacture source terminals of the P-type or N-type transistor. In some embodiments, contact pattern 207b is usable to manufacture drain terminals of the P-type or N-type transistor.

In some embodiments, the set of contact patterns 207 are overlapped by the set of active region patterns 202. The set of contact patterns 207 is located on a third layout level. In some embodiments, the third layout level corresponds to the back-side contact level or a back-side MD (BMD) level of one or more of layout design 200 or integrated circuits 300, 400, 500, 600, 700, 800, 900 or 1000. In some embodiments, the third layout level is different from the first layout level and the second layout level.

In some embodiments, the BMD level is above the BM0 level. In some embodiments, the BMD level is below a back-side 303b of integrated circuit 300. In some embodiments, the BMD level is below the OD level, the POLY level, the MD level, the M0 level, the M1 level, the M2 level and the M3 level.

Other configurations, arrangements on other layout levels or quantities of patterns in the set of contact patterns 207 are within the scope of the present disclosure.

Each cell layout of the set of cell layouts 211 further includes one or more contact patterns 208a, 208b, 208c or 208d (collectively referred to as a “set of contact patterns 208”) extending in the second direction Y.

Each of the contact patterns of the set of contact patterns 208 is separated from an adjacent contact pattern of the set of contact patterns 208 in at least the first direction X or the second direction Y.

The set of contact patterns 208 is usable to manufacture a corresponding set of contacts 306 of integrated circuit 300, 400, 500, 600, 700, 800, 900 or 1000.

In some embodiments, contact pattern 208a, 208b, 208c or 208d of the set of contact patterns 208 is usable to manufacture corresponding contact 308a, 308b, 308c or 308d of the set of contact patterns 306. In some embodiments, the set of contact patterns 208 is also referred to as a set of MD patterns.

In some embodiments, at least one of contact pattern 208a, 208b, 208c or 208d of the set of contact patterns 208 is usable to manufacture source or drain terminals of one of the N-type or P-type transistors of integrated circuit 300, 400, 500, 600, 700, 800, 900 or 1000.

In some embodiments, contact pattern 208a is usable to manufacture source terminals of a P-type or N-type transistor. In some embodiments, contact pattern 208a is usable to manufacture drain terminals of a P-type or N-type transistor.

In some embodiments, contact pattern 208b is usable to manufacture source terminals of the P-type or N-type transistor. In some embodiments, contact pattern 208b is usable to manufacture drain terminals of the P-type or N-type transistor.

In some embodiments, contact pattern 208c is usable to manufacture source terminals of the P-type or N-type transistor. In some embodiments, contact pattern 208c is usable to manufacture drain terminals of the P-type or N-type transistor.

In some embodiments, contact pattern 208d is usable to manufacture source terminals of the P-type or N-type transistor. In some embodiments, contact pattern 208d is usable to manufacture drain terminals of the P-type or N-type transistor.

In some embodiments, the set of contact patterns 208 overlap the set of active region patterns 204. The set of contact patterns 208 is located on the second layout level.

Other configurations, arrangements on other layout levels or quantities of patterns in the set of contact patterns 208 are within the scope of the present disclosure.

Layout design 200 further includes one or more conductive feature patterns 230a, 230b, 230c, 230d, 230e or 230f (collectively referred to as a “set of conductive feature patterns 230”) extending in the first direction X.

Each conductive feature pattern in the set of conductive feature patterns 230 is separated from another conductive feature pattern in the set of conductive feature patterns 230 in the second direction Y by a pitch P1a. In some embodiments, since each conductive feature pattern in the set of conductive feature patterns 230 is separated from another conductive feature pattern in the set of conductive feature patterns 230 in the second direction Y by a same pitch (e.g., pitch P1a), then each row (e.g., Rows 1-5) of layout design 200 has a same height (e.g., height H1), and layout design 200 has a uniform row height.

The set of conductive feature patterns 230 overlap at least one of the set of active region patterns 202 or 204, or the set of contact patterns 206, 207 or 208.

The set of conductive feature patterns 230 is usable to manufacture a corresponding set of conductors 330 of integrated circuit 300, 400, 500, 600, 700, 800, 900 or 1000. Conductive feature patterns 230a, 230b, 230c, 230d, 230e or 230f are usable to manufacture corresponding conductors 330a, 330b, 330c, 330d, 330e or 330f of integrated circuit 300, 400, 500, 600, 700, 800, 900 or 1000. In some embodiments, at least one conductor of the set of conductors 330 is located on the front-side 303a of integrated circuit 300, 400, 500, 600, 700, 800, 900 or 1000.

In some embodiments, the set of conductive feature patterns 230 is located on a fourth layout level. In some embodiments, the fourth layout level is different from at least one of the first layout level, the second layout level or the third layout level. In some embodiments, the fourth layout level corresponds to the M0 level of one or more of layout design 200 or integrated circuits 300, 400, 500, 600, 700, 800, 900 or 1000. In some embodiments, the M0 level is above the OD level, the POLY level, the MD level, the BMD level and the BM0 level.

In some embodiments, the set of conductive feature patterns 230 correspond to 6 M0 routing tracks. Other numbers of M0 routing tracks are within the scope of the present disclosure. Other M0 track assignments are within the scope of the present disclosure.

Other configurations, pitches, arrangements on other layout levels or quantities of patterns in the set of conductive feature patterns 230 are within the scope of the present disclosure.

Layout design 200 further includes one or more conductive feature patterns 232a, 232b, 232c, 232d, 232e or 232f (collectively referred to as a “set of conductive feature patterns 232”) extending in the first direction X.

Each conductive feature pattern in the set of conductive feature patterns 232 is separated from another conductive feature pattern in the set of conductive feature patterns 232 in the second direction Y by a pitch P1b. In some embodiments, since each conductive feature pattern in the set of conductive feature patterns 232 is separated from another conductive feature pattern in the set of conductive feature patterns 232 in the second direction Y by a same pitch (e.g., pitch P1b), then each row (e.g., Rows 1-5) of layout design 200 has a same height (e.g., height H1), and layout design 200 has a uniform row height.

The pitch P1b is the same as the pitch P1a. In some embodiments, the pitch P1b is different from the pitch P1a.

The set of conductive feature patterns 232 is overlapped by at least one of the set of active region patterns 202 or 204, the set of contact patterns 206, 207 or 208 or the set of conductive feature patterns 232.

The set of conductive feature patterns 230 and 232 are separated from one another in the third direction Z.

The set of conductive feature patterns 232 is usable to manufacture a corresponding set of conductors 332 of integrated circuit 300, 400, 500, 600, 700, 800, 900 or 1000. Conductive feature patterns 232a, 232b, 232c, 232d, 232e or 232f are usable to manufacture corresponding conductors 332a, 332b, 332c, 332d, 332e or 332f of integrated circuit 300, 400, 500, 600, 700, 800, 900 or 1000. In some embodiments, at least one conductor of the set of conductors 332 is located on the back-side 303b of integrated circuit 300, 400, 500, 600, 700, 800, 900 or 1000.

In some embodiments, the set of conductive feature patterns 232 is located on a fifth layout level. In some embodiments, the fifth layout level is different from at least one of the first layout level, the second layout level, the third layout level and the fourth layout level. In some embodiments, the fifth layout level corresponds to the BM0 level of one or more of layout design 200 or integrated circuits 300, 400, 500, 600, 700, 800, 900 or 1000. In some embodiments, the BM0 level is below the OD level, the POLY level, the MD level, the BMD level and the M1 level.

In some embodiments, the set of conductive feature patterns 232 corresponds to 6 BM0 routing tracks. Other numbers of BM0 routing tracks are within the scope of the present disclosure. Other BM0 track assignments are within the scope of the present disclosure.

In some embodiments, layout design 200 includes front-side power rails (e.g., the set of conductive feature patterns 230) and back-side power rails (e.g., the set of conductive feature patterns 232), and a first set of transistors (e.g., set of active region patterns 202) and a second set of transistors (e.g., set of active region patterns 204) with different sizes or widths resulting in a more flexible layout design 200.

Other configurations, pitches, arrangements on other layout levels or quantities of patterns in the set of conductive feature patterns 232 are within the scope of the present disclosure.

The set of via patterns 270 includes one or more of via patterns 270a or 270b.

In some embodiments, the set of via patterns 270 is between the set of conductive feature patterns 230 and the set of contact patterns 206.

Other configurations, arrangements on other layout levels or quantities of via patterns in at least set of via patterns 270 are within the scope of the present disclosure.

The set of via patterns 272 includes one or more of via patterns 272a, 272b, 272c or 272d.

In some embodiments, the set of via patterns 272 is between the set of conductive feature patterns 230 and the set of contact patterns 208.

Other configurations, arrangements on other layout levels or quantities of via patterns in at least set of via patterns 272 are within the scope of the present disclosure.

Layout design 200 further includes at least one of cell layout patterns 212a or 212b (collectively referred to as a “set of cell layouts 212”) extending in at least the first direction X or the second direction Y.

The set of cell layouts 212 is usable to manufacture a corresponding set of cells 312 of integrated circuit 300, 400, 500, 600, 700, 800, 900 or 1000. In some embodiments, cell layout pattern 212a or 212b is usable to manufacture corresponding cell 312a or 312b of the set of cells 310 of integrated circuit 300, 400, 500, 600, 700, 800, 900 or 1000.

Each cell layout 212a or 212b is located within two corresponding rows of layout design 200. For example, cell layout 212a is located in rows 4 and 5 of layout design 200, and cell layout 212b is located in rows 3 and 4 of layout design 200. Other rows or positions for cell layout 212a or 212b are within the scope of the present disclosure. Other numbers of cell layouts 212a or 212b are within the scope of the present disclosure.

Cell layout 212a includes at least via pattern 220a extending in the third direction Z.

Cell layout 212b includes at least via pattern 220b extending in the third direction Z.

A set of via patterns 220 includes at least one of via pattern 220a or 220b.

Each of the via patterns of the set of via patterns 220 is separated from an adjacent via pattern of the set of via patterns 220 in at least the first direction X or the second direction Y.

The set of via patterns 220 is usable to manufacture a corresponding set of vias 320 of integrated circuit 300, 400, 500, 600, 700, 800, 900 or 1000.

In some embodiments, via pattern 220a or 220b of the set of via patterns 220 is usable to manufacture corresponding via 320a or 320b of the set of via patterns 320. In some embodiments, the set of via patterns 220 is also referred to as a set of feed-through via (FTV) patterns.

In some embodiments, the set of via patterns 220 are overlapped by the set of conductive feature patterns 230. In some embodiments, the set of via patterns 252 is between the set of conductive feature patterns 230 and the set of conductive feature patterns 232.

Via pattern 220a is between conductive feature pattern 230e and conductive feature pattern 232e. Via pattern 220b is between conductive feature pattern 230d and conductive feature pattern 232d.

The set of via patterns 220 is positioned at the FTV level of one or more of layout design 200 or integrated circuits 300, 400, 500, 600, 700, 800, 900 or 1000. In some embodiments, the FTV level is above the BM0 level. In some embodiments, the FTV level is below the M0 level, the M1 level, the M2 level and the M3 level. In some embodiments, the FTV level is between the M0 level and the BM0 level. In some embodiments, the FTV level is between the fourth layout level and the fifth layout level. Other layout levels are within the scope of the present disclosure.

In some embodiments, the set of via patterns 220 are positioned adjacent or directly next to the set of cells 211. In some embodiments, the set of via patterns 220 are positioned adjacent or directly next to the set of cells 211 thereby reducing resistance from the set of conductive feature patterns 230 or 232, by reducing the distance between the set of cells 211 and the corresponding supply voltage VDD or reference supply voltage VSS. In some embodiments, layout design 200 has lower resistance than other approaches thereby improving performance.

Other configurations, arrangements on other layout levels or quantities of patterns in the set of via patterns 220 are within the scope of the present disclosure.

Other configurations, arrangements on other layout levels or quantities of patterns in the set of cell patterns 212 are within the scope of the present disclosure.

Layout design 200 further includes one or more conductive feature patterns 240a or 240b (collectively referred to as a “set of conductive feature patterns 240”) extending in the second direction Y.

Each conductive feature pattern in the set of conductive feature patterns 240 is separated from another conductive feature pattern in the set of conductive feature patterns 240 in the first direction X.

The set of conductive feature patterns 240 overlap at least one of the set of active region patterns 202 or 204, the set of contact patterns 206, 207 or 208 or the set of conductive feature patterns 230 or 232.

The set of conductive feature patterns 240 is usable to manufacture a corresponding set of conductors 340 of integrated circuit 300, 400, 500, 600, 700, 800, 900 or 1000. Conductive feature patterns 240a or 240b are usable to manufacture corresponding conductors 340a or 340b of integrated circuit 300, 400, 500, 600, 700, 800, 900 or 1000. In some embodiments, at least one conductor of the set of conductors 340 is located on the front-side 303a of integrated circuit 300, 400, 500, 600, 700, 800, 900 or 1000.

In some embodiments, the set of conductive feature patterns 240 is located on a sixth layout level. In some embodiments, the sixth layout level is different from at least one of the first layout level, the second layout level, the third layout level, the fourth layout level or the fifth layout level. In some embodiments, the sixth layout level corresponds to the M1 level of one or more of layout design 200 or integrated circuits 300, 400, 500, 600, 700, 800, 900 or 1000. In some embodiments, the M1 level is above the OD level, the POLY level, the MD level, the M0 level, the BMD level and the BM0 level.

In some embodiments, the set of conductive feature patterns 240 corresponds to 2 M1 routing tracks. Other numbers of M1 routing tracks are within the scope of the present disclosure.

Other configurations, arrangements on other layout levels or quantities of patterns in the set of conductive feature patterns 240 are within the scope of the present disclosure.

Layout design 200 further includes one or more via patterns 242a, 242b, 242c, 242d, 242e or 242f (collectively referred to as a “set of via patterns 242”).

The set of via patterns 242 is usable to manufacture a corresponding set of vias 342 of integrated circuit 300, 400, 500, 600, 700, 800, 900 or 1000. In some embodiments, via patterns 242a, 242b, 242c, 242d, 242e or 242f of the set of via patterns 242 are usable to manufacture corresponding vias 342a, 342b, 342c, 342d, 342e or 342f of the set of vias 342 of integrated circuit 300, 400, 500, 600, 700, 800, 900 or 1000.

In some embodiments, the set of via patterns 242 is between the set of conductive feature patterns 240 and the set of conductive feature patterns 230.

Via pattern 242a is between conductive feature pattern 240a and conductive feature pattern 230a. Via pattern 242b is between conductive feature pattern 240a and conductive feature pattern 230c. Via pattern 242c is between conductive feature pattern 240a and conductive feature pattern 230e. Via pattern 242d is between conductive feature pattern 240b and conductive feature pattern 230b. Via pattern 242e is between conductive feature pattern 240b and conductive feature pattern 230d. Via pattern 242f is between conductive feature pattern 240b and conductive feature pattern 230f.

The set of via patterns 242 is positioned at a via over M0 (V0) level of one or more of layout design 200 or integrated circuits 300, 400, 500, 600, 700, 800, 900 or 1000. In some embodiments, the V0 level is above the OD level, the POLY level, the MD level, the M0 level, the BMD level and the BM0 level. In some embodiments, the V0 level is below the M1 level. In some embodiments, the V0 level is between the M0 level and the M1 level. In some embodiments, the V0 level is between the fourth layout level and the sixth layout level. Other layout levels are within the scope of the present disclosure.

Other configurations, arrangements on other layout levels or quantities of patterns in at least set of via patterns 242 are within the scope of the present disclosure.

Layout design 200 further includes at least conductive feature pattern 250a (collectively referred to as a “set of conductive feature patterns 250”) extending in the first direction X.

Each conductive feature pattern in the set of conductive feature patterns 250 is separated from another conductive feature pattern in the set of conductive feature patterns 250 in the second direction Y.

The set of conductive feature patterns 250 overlap at least one of the set of active region patterns 202 or 204, the set of contact patterns 206, 207 or 208 or the set of conductive feature patterns 230, 232 or 240.

The set of conductive feature patterns 250 is usable to manufacture a corresponding set of conductors 350 of integrated circuit 300, 400, 500, 600, 700, 800, 900 or 1000. Conductive feature pattern 250a is usable to manufacture a corresponding conductor 350a of integrated circuit 300, 400, 500, 600, 700, 800, 900 or 1000. In some embodiments, at least one conductor of the set of conductors 350 is located on the front-side 303a of integrated circuit 300, 400, 500, 600, 700, 800, 900 or 1000.

In some embodiments, the set of conductive feature patterns 250 is located on a seventh layout level. In some embodiments, the seventh layout level is different from at least one of the first layout level, the second layout level, the third layout level, the fourth layout level, the fifth layout level or the sixth layout level. In some embodiments, the seventh layout level corresponds to the M2 level of one or more of layout design 200 or integrated circuits 300, 400, 500, 600, 700, 800, 900 or 1000. In some embodiments, the M2 level is above the OD level, the POLY level, the MD level, the M0 level, the M1 level, the BMD level and the BM0 level.

In some embodiments, the set of conductive feature patterns 250 corresponds to 1 M2 routing track. Other numbers of M2 routing tracks are within the scope of the present disclosure.

Other configurations, arrangements on other layout levels or quantities of patterns in the set of conductive feature patterns 250 are within the scope of the present disclosure.

Layout design 200 further includes at least via pattern 252a (collectively referred to as a “set of via patterns 252”).

The set of via patterns 252 is usable to manufacture a corresponding set of vias 352 of integrated circuit 300, 400, 500, 600, 700, 800, 900 or 1000. In some embodiments, via pattern 252a of the set of via patterns 252 are usable to manufacture corresponding via 352a of the set of vias 352 of integrated circuit 300, 400, 500, 600, 700, 800, 900 or 1000.

In some embodiments, the set of via patterns 252 is between the set of conductive feature patterns 250 and the set of conductive feature patterns 240.

Via pattern 252a is between conductive feature pattern 250a and conductive feature pattern 240a.

The set of via patterns 252 is positioned at a via over M1 (V1) level of one or more of layout design 200 or integrated circuits 300, 400, 500, 600, 700, 800, 900 or 1000. In some embodiments, the V1 level is above the OD level, the POLY level, the MD level, the M0 level, the M1 level, the BMD level and the BM0 level. In some embodiments, the V1 level is below the M2 level. In some embodiments, the V1 level is between the M1 level and the M2 level. In some embodiments, the V1 level is between the sixth layout level and the seventh layout level. Other layout levels are within the scope of the present disclosure.

Other configurations, arrangements on other layout levels or quantities of patterns in at least set of via patterns 252 are within the scope of the present disclosure.

Layout design 200 further includes at least conductive feature pattern 260a (collectively referred to as a “set of conductive feature patterns 260”) extending in the second direction Y.

Each conductive feature pattern in the set of conductive feature patterns 260 is separated from another conductive feature pattern in the set of conductive feature patterns 260 in the first direction X.

The set of conductive feature patterns 260 overlap at least one of the set of active region patterns 202 or 204, the set of contact patterns 206, 207 or 208 or the set of conductive feature patterns 230, 232, 240 or 250.

The set of conductive feature patterns 260 is usable to manufacture a corresponding set of conductors 360 of integrated circuit 300, 400, 500, 600, 700, 800, 900 or 1000. Conductive feature pattern 260a is usable to manufacture a corresponding conductor 360a of integrated circuit 300, 400, 500, 600, 700, 800, 900 or 1000. In some embodiments, at least one conductor of the set of conductors 360 is located on the front-side 303a of integrated circuit 300, 400, 500, 600, 700, 800, 900 or 1000.

In some embodiments, the set of conductive feature patterns 260 is located on an eighth layout level. In some embodiments, the eighth layout level is different from at least one of the first layout level, the second layout level, the third layout level, the fourth layout level, the fifth layout level, the sixth layout level or the seventh layout level. In some embodiments, the eighth layout level corresponds to the M3 level of one or more of layout design 200 or integrated circuits 300, 400, 500, 600, 700, 800, 900 or 1000. In some embodiments, the M3 level is above the OD level, the POLY level, the MD level, the M0 level, the M1 level, the M2 level, the BMD level and the BM0 level.

In some embodiments, the set of conductive feature patterns 260 corresponds to 1 M3 routing track. Other numbers of M3 routing tracks are within the scope of the present disclosure.

Other configurations, arrangements on other layout levels or quantities of patterns in the set of conductive feature patterns 260 are within the scope of the present disclosure.

Layout design 200 further includes at least via pattern 262a (collectively referred to as a “set of via patterns 262”).

The set of via patterns 262 is usable to manufacture a corresponding set of vias 362 of integrated circuit 300, 400, 500, 600, 700, 800, 900 or 1000. In some embodiments, via pattern 262a of the set of via patterns 262 are usable to manufacture corresponding via 362a of the set of vias 362 of integrated circuit 300, 400, 500, 600, 700, 800, 900 or 1000.

In some embodiments, the set of via patterns 262 is between the set of conductive feature patterns 260 and the set of conductive feature patterns 250.

Via pattern 262a is between conductive feature pattern 260a and conductive feature pattern 250a.

The set of via patterns 262 is positioned at a via over M2 (V2) level of one or more of layout design 200 or integrated circuits 300, 400, 500, 600, 700, 800, 900 or 1000. In some embodiments, the V2 level is above the OD level, the POLY level, the MD level, the M0 level, the M1 level, the M2 level, the BMD level and the BM0 level. In some embodiments, the V2 level is below the M3 level. In some embodiments, the V2 level is between the M2 level and the M3 level. In some embodiments, the V2 level is between the seventh layout level and the eighth layout level. Other layout levels are within the scope of the present disclosure.

Other configurations, arrangements on other layout levels or quantities of patterns in at least set of via patterns 262 are within the scope of the present disclosure.

In some embodiments, by including at least one or more of the set of conductive feature pattern 240, the set of via patterns 242, the set of conductive feature pattern 250, the set of via patterns 252, the set of via patterns 262 or the set of conductive feature pattern 260, layout design 200 has less resistance than other approaches thereby improving performance.

Other configurations, arrangements on other layout levels or quantities of patterns in layout design 200 are within the scope of the present disclosure.

FIGS. 3A-3G are diagrams of an integrated circuit 300, in accordance with some embodiments.

FIGS. 3A-3C are corresponding diagrams of corresponding portions 300A-300C of an integrated circuit 300, simplified for ease of illustration.

Portion 300A includes one or more features of integrated circuit 300 of the OD level, the MD level, the M0 level, the M1 level, the M2 level, the M3 level, the V0 level, the V1 level, the V2 level and the FTV level. Portion 300A is manufactured by portion 200A.

Portion 300B includes one or more features of integrated circuit 300 of the OD level, the BMD level, the BM0 level and the FTV level. Portion 300B is manufactured by portion 200B.

Portion 300C includes one or more features of integrated circuit 300 of the OD level, the MD level, the M0 level and the FTV level. Portion 300C is manufactured by portion 200C.

FIGS. 3D-3G are corresponding cross-sectional views of integrated circuit 300, in accordance with some embodiments. FIG. 3D is a cross-sectional view of integrated circuit 300 as intersected by plane A-A′, in accordance with some embodiments. FIG. 3E is a cross-sectional view of integrated circuit 300 as intersected by plane B-B′, in accordance with some embodiments. FIG. 3F is a cross-sectional view of integrated circuit 300 as intersected by plane C-C′, in accordance with some embodiments. FIG. 3G is a cross-sectional view of integrated circuit 300 as intersected by plane D-D′, in accordance with some embodiments.

Components that are the same or similar to those in one or more of FIG. 1, 2A-2B, 3A-3G, 4A-4B, 5A-5B, 6A-6B6A-6B, 7A-7B, 8A-8B, 9A-9B or 10A-10B are given the same reference numbers, and detailed description thereof is thus omitted.

Integrated circuit 300 is manufactured by layout design 200. Integrated circuit 300 is cell 301. Cell 301 is manufactured by cell 201, and similar detailed description is omitted for brevity. Structural relationships including alignment, lengths and widths, as well as configurations and layers of integrated circuit 300, 400, 500, 600, 700, 800, 900 or 1000 are similar to the structural relationships and configurations and layers of layout design 200 of FIGS. 2A-2B, and similar detailed description will not be described in at least FIGS. 3A-3G, for brevity. For example, in some embodiments, at least one or more widths, lengths or pitches of layout design 200 is similar to corresponding widths, lengths or pitches of integrated circuit 300, 400, 500, 600, 700, 800, 900 or 1000, and similar detailed description is omitted for brevity. For example, in some embodiments, at least cell boundary 201a, 201b, 201c or 201d is similar to at least corresponding cell boundary 301a, 301b, 301c or 301d of integrated circuit 300, and similar detailed description is omitted for brevity.

Integrated circuit 300 includes at least one or more of the set of active regions 302 and 304, the set of contacts 306, the set of contacts 307, the set of contacts 308, the set of conductors 330, the set of conductors 332, the set of vias 320, the set of conductors 340, the set of vias 342, the set of conductors 350, the set of vias 352, the set of conductors 360, the set of vias 362, a substrate 380, or an insulating region 382.

Cell 301 is manufactured by cell 201, and similar detailed description is omitted for brevity.

Integrated circuit 300 further includes a portion 390 and a portion 392.

In some embodiments, portion 390 is manufactured by portion 290 of layout design 200 of FIGS. 2A-2C or standard cell designs 102a, 102b and 102c of layout design 100A of FIG. 1A, and similar detailed description is omitted for brevity. In some embodiments, portion 392 is manufactured by portion 292 of layout design 200 of FIGS. 2A-2C or standard cell designs 104a and 104b of layout design 100A of FIG. 1A, and similar detailed description is omitted for brevity.

Integrated circuit 300 further includes at least one of cells 310a, 310b or 310c (collectively referred to as a “set of cells 310”) and at least one of cells 311a or 311b (collectively referred to as a “set of cells layouts 311”).

Each cell of the set of cells 310 includes at least one of active region 302a or 302b (collectively referred to as a “set of active regions 302”).

Each cell of the set of cells 311 includes at least one of active region 304a or 304b (collectively referred to as a “set of active regions 304”).

The set of active regions 302 and 304 are embedded in substrate 380. Substrate 380 has a front-side 303a and a back-side 303b opposite from the front-side 303a. In some embodiments, at least the set of active regions 302 and 304 or the set of contacts 306 and 308 are formed in the front-side 303a of substrate 380. In some embodiments, at least the set of contacts 307 are formed in the back-side 303b of substrate 380.

In some embodiments, the set of active regions 302 and 304 correspond to active regions of CFET transistors. In some embodiments, the set of active regions 302 and 304 correspond to nanosheet structures (not labelled) of nanosheet transistors. In some embodiments, the set of active regions 302 or 304 include drain regions and source regions grown by an epitaxial growth process. In some embodiments, the set of active regions 302 or 304 include drain regions and source regions that are grown with an epitaxial material at the corresponding drain regions and source regions.

Other transistor types are within the scope of the present disclosure. For example, in some embodiments, the set of active regions 302 or 304 corresponds to nanowire structures (not shown) of nanowire transistors. In some embodiments, the set of active regions 302 or 304 corresponds to planar structures (not shown) of planar transistors. In some embodiments, the set of active regions 302 or 304 corresponds to fin structures (not shown) of finFETs.

In some embodiments, at least active region 302a is an N-type doped S/D region, and at least active region 302b is a P-type doped S/D region embedded in a dielectric material of substrate 380. In some embodiments, at least active region 304a is a P-type doped S/D region, and at least active region 304b is an N-type doped S/D region embedded in a dielectric material of substrate 380.

In some embodiments, at least active region 302a is a P-type doped S/D region, and at least active region 302b is an N-type doped S/D region embedded in a dielectric material of substrate 380. In some embodiments, at least active region 304a is an N-type doped S/D region, and at least active region 304b is a P-type doped S/D region embedded in a dielectric material of substrate 380.

Active regions 302a and 302b each have a width W1b in the second direction Y. In some embodiments, the width W1b is referred to as a first size.

Active regions 304a and 304b each have a width W2b in the second direction Y. In some embodiments, the width W2b is referred to as a second size.

In some embodiments, an increase in the width W1b causes the corresponding speed and driving strength of the corresponding transistor(s) to increase. In some embodiments, a decrease in the width W1a causes the corresponding speed and driving strength of the corresponding transistor(s) to decrease.

In some embodiments, an increase in the width W2b causes the corresponding speed and driving strength of the corresponding transistor(s) to increase. In some embodiments, a decrease in the width W2b causes the corresponding speed and driving strength of the corresponding transistor(s) to decrease.

In some embodiments, the width W1b is greater than the width W2b. In these embodiments, the corresponding speed and driving strength of the corresponding active region pattern 202a or 202b of the corresponding transistor(s) is greater than the corresponding speed and driving strength of the corresponding active region pattern 204a or 204b of the corresponding transistor(s), and the set of active regions 302 are referred to as “large devices” and the set of active regions 304 are referred to as “small devices.”

Other configurations, arrangements on other layout levels or quantities of structures in the set of active regions 302 or 304 are within the scope of the present disclosure.

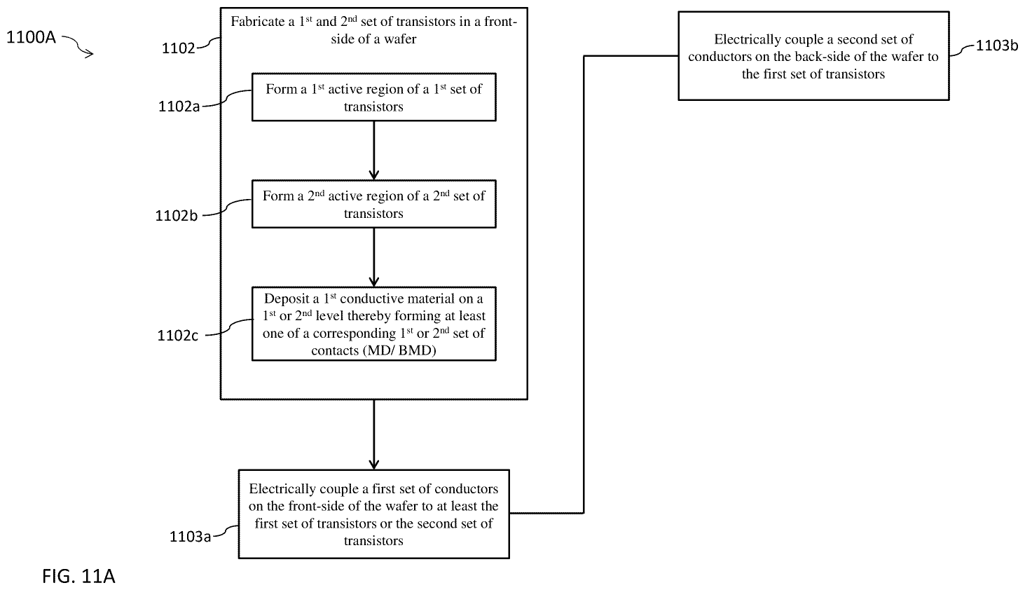

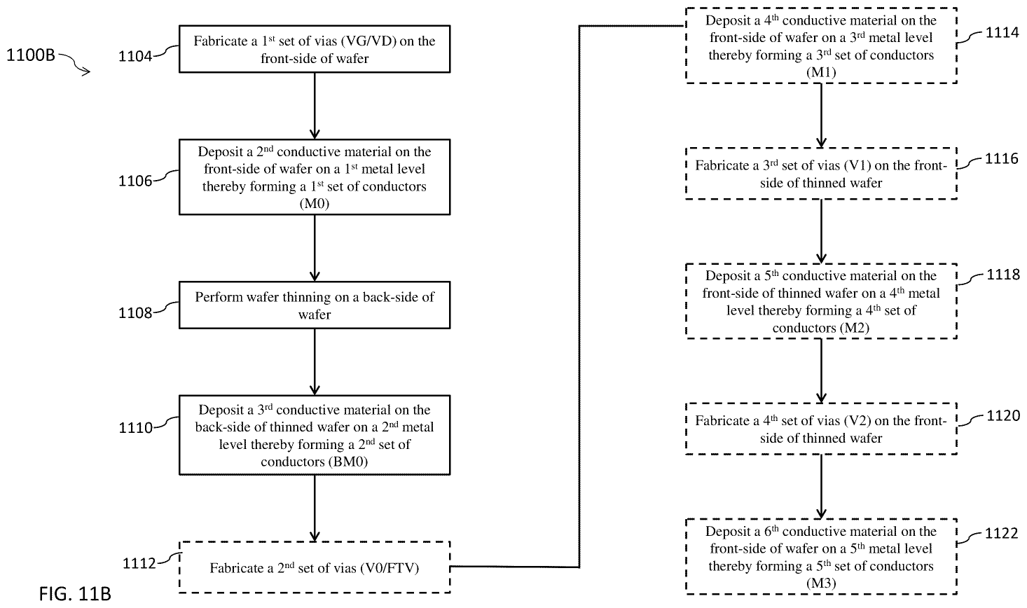

Insulating region 382 is configured to electrically isolate one or more elements of the set of active regions 302 and 304, the set of contacts 306, the set of contacts 307, the set of contacts 308, the set of conductors 330, the set of conductors 332, the set of vias 320, the set of conductors 340, the set of vias 342, the set of conductors 350, the set of vias 352, the set of conductors 360, and the set of vias 362 from one another. In some embodiments, insulating region 382 includes multiple insulating regions deposited at different times from each other during method 1100 (FIG. 11). In some embodiments, insulating region 382 is a dielectric material. In some embodiments, the dielectric material includes silicon dioxide, silicon oxy-nitride, or the like.

Other configurations, arrangements on other layout levels or other numbers of portions in insulating region 382 are within the scope of the present disclosure.

Each cell of the set of cells 310 further includes one or more contacts 306a or 306b (collectively referred to as a “set of contacts 306”).

In some embodiments, the set of contacts 306 and 308 are in the front-side 303a of substrate 380.

In some embodiments, at least one of contact 306a or 306b of the set of contacts 306 is a source terminal or a drain terminal of one of the N-type or P-type transistors of integrated circuit 300, 400, 500, 600, 700, 800, 900 or 1000.

In some embodiments, contact 306a is a source terminal of a P-type or N-type transistor. In some embodiments, contact 306a is a drain terminal of a P-type or N-type transistor.

In some embodiments, contact pattern 306b is a source terminal of the P-type or N-type transistor. In some embodiments, contact 306b is a drain terminal of the P-type or N-type transistor.

In some embodiments, one or more contacts of the set of contacts 306 overlaps a corresponding active region of the set of active regions 302, thereby electrically coupling the corresponding active region of the set of active regions 302, and the source or drain of the corresponding transistor.

In some embodiments, the set of contacts 306 encapsulates the set of active regions 302.

Other configurations, arrangements on other layout levels or quantities of contacts in the set of contacts 306 are within the scope of the present disclosure.

Each cell of the set of cells 310 further includes one or more contacts 307a or 307b (collectively referred to as a “set of contacts 307”).

In some embodiments, at least the set of contacts 307 are in the back-side 303b of substrate 380.

In some embodiments, at least one of contact pattern 307a or 307b of the set of contacts 307 is a source or drain terminal of one of the N-type or P-type transistors of integrated circuit 300, 400, 500, 600, 700, 800, 900 or 1000.

In some embodiments, contact 307a is a source terminal of a P-type or N-type transistor. In some embodiments, contact 307a is a drain terminal of a P-type or N-type transistor.

In some embodiments, contact pattern 307b is a source terminal of the P-type or N-type transistor. In some embodiments, contact 307b is a drain terminal of the P-type or N-type transistor.

Other configurations, arrangements on other layout levels or quantities of contacts in the set of contacts 307 are within the scope of the present disclosure.

Each cell of the set of cells 311 further includes one or more contacts 308a, 308b, 308c or 308d (collectively referred to as a “set of contacts 308”).

In some embodiments, at least one of contact pattern 308a, 308b, 308c or 308d of the set of contacts 308 is a source or drain terminal of one of the N-type or P-type transistors of integrated circuit 300, 400, 500, 600, 700, 800, 900 or 1000.

In some embodiments, contact 308a is a source terminal of a P-type or N-type transistor. In some embodiments, contact 308a is a drain terminal of a P-type or N-type transistor.

In some embodiments, contact pattern 308b is a source terminal of the P-type or N-type transistor. In some embodiments, contact 308b is a drain terminal of the P-type or N-type transistor.

In some embodiments, contact pattern 308c is a source terminal of the P-type or N-type transistor. In some embodiments, contact 308c is a drain terminal of the P-type or N-type transistor.

In some embodiments, contact pattern 308d is a source terminal of the P-type or N-type transistor. In some embodiments, contact 308d is a drain terminal of the P-type or N-type transistor.

Other configurations, arrangements on other layout levels or quantities of contacts in the set of contacts 308 are within the scope of the present disclosure.

The set of conductors 330 is M0 routing tracks. In some embodiments, the set of conductors 330 corresponds to 6 M0 routing tracks.

Each conductor in the set of conductors 330 is separated from another conductor in the set of conductors 330 in the second direction Y by a pitch P1a′. In some embodiments, since each conductor in the set of conductors 330 is separated from another conductor in the set of conductors 330 in the second direction Y by a same pitch (e.g., pitch P1a′), then each row (e.g., Rows 1-5) of integrated circuit 300 has a same height (e.g., height H1), and integrated circuit 300 has a uniform row height.

The set of conductors 332 is BM0 routing tracks. In some embodiments, the set of conductors 332 corresponds to 6 BM0 routing tracks.

Each conductor in the set of conductors 332 is separated from another conductor in the set of conductors 332 in the second direction Y by a pitch P1b′. In some embodiments, since each conductor in the set of conductors 332 is separated from another conductor in the set of conductors 332 in the second direction Y by a same pitch (e.g., pitch P1b′), then each row (e.g., Rows 1-5) of integrated circuit 300 has a same height (e.g., height H1), and integrated circuit 300 has a uniform row height.

The pitch P1b′ is the same as the pitch P1a′. In some embodiments, the pitch P1b′ is different from the pitch P1a′.

The set of conductors 330 overlap at least one of the set of active regions 302 or 304, or the set of contacts 306, 307 or 308. The set of conductors 332 is overlapped by at least one of the set of active regions 302 or 304, the set of contacts 306, 307 or 308 or the set of conductors 330.

In some embodiments, the set of conductors 330 is located on the front-side 303a of integrated circuit 300, 400, 500, 600, 700, 800, 900 or 1000. In some embodiments, the set of conductors 332 is located on the back-side 303b of integrated circuit 300, 400, 500, 600, 700, 800, 900 or 1000.

At least one of conductor 330a, 330c or 330e is configured to supply voltage VDD. In some embodiments, at least one of conductor 330a, 330c or 330e is configured to supply reference supply voltage VSS.

At least one of conductor 330b, 330d or 330f is configured to supply reference supply voltage VSS. In some embodiments, at least one of conductor 330b, 330d or 330f is configured to supply voltage VDD.

At least one of conductor 332a, 332c or 332e is configured to supply voltage VDD. In some embodiments, at least one of conductor 332a, 332c or 332e is configured to supply reference supply voltage VSS.

At least one of conductor 332b, 332d or 332f is configured to supply reference supply voltage VSS. In some embodiments, at least one of conductor 332b, 332d or 332f is configured to supply voltage VDD.

In some embodiments, the set of conductors 330 and 332 are referred to as a corresponding set of power rails.

In some embodiments, the set of conductors 330 and 332 are routing tracks in other layers.

In some embodiments, integrated circuit 300 includes front-side power rails (e.g., the set of conductors 330) and back-side power rails (e.g., the set of conductors 332), and a first set of transistors (e.g., set of active regions 302) and a second set of transistors (e.g., set of active regions 304) with different sizes or widths resulting in a more flexible integrated circuit 300 and corresponding layout design 200.

Other configurations, arrangements on other layout levels or quantities of conductors in the set of conductors 330 and 332 are within the scope of the present disclosure.

The set of vias 370 includes one or more of vias 370a or 370b.

In some embodiments, the set of vias 370 is between the set of conductors 330 and the set of contacts 306.

The set of vias 370 is configured to electrically couple one or more conductors of the set of conductors 330 to one or more contacts of the set of contacts 306, and vice versa.

Other configurations, arrangements on other layout levels or quantities of vias in at least set of vias 370 are within the scope of the present disclosure.

The set of vias 372 includes one or more of vias 372a, 372b, 372c or 372d.

In some embodiments, the set of vias 372 is between the set of conductors 330 and the set of contacts 308.

The set of vias 372 is configured to electrically couple one or more conductors of the set of conductors 330 to one or more contacts of the set of contacts 308, and vice versa.

Other configurations, arrangements on other layout levels or quantities of vias in at least set of vias 372 are within the scope of the present disclosure.

Integrated circuit 300 further includes at least one of cells 312a or 312b (collectively referred to as a “set of cells 312”).

Cell 312a includes at least via 320a.

Cell 312b includes at least via 320b.

A set of vias 320 includes at least one of via 320a or 320b.

The set of vias 320 extends in the third direction Z through substrate 380. The set of vias 320 is configured to electrically couple a corresponding conductor of the set of conductors 330 to a corresponding conductor of the set of conductors 332, and vice versa. The set of vias 320 is between the set of conductors 330 and the set of conductors 332. The set of vias 320 are overlapped by the set of conductors 330. The set of vias 320 are over the set of conductors 332.

Via 320a is between conductor 330e and conductor 332e. Via 320a is configured to electrically couple conductor 330e and conductor 332e together. In some embodiments, via 320a is configured to supply the supply voltage VDD from the back-side 303b of integrated circuit 300, 400, 500, 600, 700, 800, 900 or 1000 to the front-side 303a. For example, in some embodiments, via 320a is configured to supply the supply voltage VDD from conductor 332e to the conductor 330e.

Via 320b is between conductor 330d and conductor 332d. Via 320b is configured to electrically couple conductor 330d and conductor 332d together. In some embodiments, via 320b is configured to supply the reference voltage VSS from the back-side 303b of integrated circuit 300, 400, 500, 600, 700, 800, 900 or 1000 to the front-side 303a. For example, in some embodiments, via 320b is configured to supply the reference voltage VSS from conductor 332d to the conductor 330d.

In some embodiments, the set of vias 320 are positioned adjacent or directly next to the set of cells 311. In some embodiments, the set of vias 320 are positioned adjacent or directly next to the set of cells 311 thereby reducing resistance from the set of conductors 330 or 332, by reducing the distance between the set of cells 311 and the corresponding supply voltage VDD or reference supply voltage VSS. In some embodiments, integrated circuit 300 has lower resistance than other approaches thereby improving performance.

Other configurations, arrangements on other layout levels or quantities of vias in the set of vias 320 are within the scope of the present disclosure.

Other configurations, arrangements on other layout levels or quantities of cells in the set of cells 312 are within the scope of the present disclosure.

The set of conductors 340 includes one or more of conductors 340a or 340b.

The set of conductors 340 corresponds to 2 M1 routing tracks. Other number of M1 routing tracks are within the scope of the present disclosure. In some embodiments, the set of conductors 340 are routing tracks in other metal layers.

The set of conductors 340 overlap at least one of the set of actives 302 or 304, the set of contacts 306, 307 or 308 or the set of conductors 330 or 332.

In some embodiments, conductor 340a is electrically coupled to at least one of conductors 330a, 330c or 330e to supply the supply voltage VDD, and is referred to as a “M1 VDD strap.”

In some embodiments, conductor 340b is electrically coupled to at least one of conductors 330b, 330d or 330f to supply the reference supply voltage VSS, and is referred to as a “M1 VSS strap.”

Other configurations, arrangements on other layout levels or quantities of conductors in the set of conductors 340 are within the scope of the present disclosure.

The set of vias 342 includes one or more of vias 342a, 342b, 342c, 342d, 342e or 342f.

In some embodiments, the set of vias 342 is between the set of conductors 340 and the set of conductors 330.

The set of vias 326 is configured to electrically couple one or more conductors of the set of conductors 330 to one or more conductors of the set of conductors 340, and vice versa.

Via 342a is configured to electrically couple conductor 340a and conductor 330a together.

Via 342b is configured to electrically couple conductor 340a and conductor 330c together.

Via 342c is configured to electrically couple conductor 340a and conductor 330e together.

Via 342d is configured to electrically couple conductor 340b and conductor 330b together.

Via 342e is configured to electrically couple conductor 340b and conductor 330d together.

Via 342f is configured to electrically couple conductor 340b and conductor 330f together.

Other configurations, arrangements on other layout levels or quantities of vias in at least set of vias 342 are within the scope of the present disclosure.

The set of conductors 350 includes at least conductor 350a.

The set of conductors 350 overlap at least one of the set of active regions 302 or 304, the set of contacts 306, 307 or 308 or the set of conductors 330, 332 or 340.

In some embodiments, conductor 350a is electrically coupled to at least one of conductors 330a, 330c or 330e by at least conductor 340a, and is configured to supply the supply voltage VDD, and is thus referred to as a “M2 VDD strap.” In some embodiments, at least one conductor of the set of conductors 350 is electrically coupled to at least one of conductors 330b, 330d or 330f by at least conductor 340a, and is configured to supply the reference supply voltage VSS, and is thus referred to as a “M2 VSS strap.”

In some embodiments, the set of conductors 350 corresponds to 1 M2 routing track. Other numbers or positions of M2 routing tracks are within the scope of the present disclosure.

Other configurations, arrangements on other layout levels or quantities of conductors in the set of conductors 350 are within the scope of the present disclosure.

The set of vias 352 includes one or more of via 352a.

In some embodiments, the set of vias 352 is between the set of conductors 350 and the set of conductors 340.

Via 352a is between conductor 350a and conductor 340a.

The set of vias 352 is configured to electrically couple one or more conductors of the set of conductors 350 to one or more conductors of the set of conductors 340, and vice versa.

Via 352a is configured to electrically couple conductor 350a and conductor 340a together.

Other configurations, arrangements on other layout levels or quantities of vias in at least set of vias 352 are within the scope of the present disclosure.

The set of conductors 360 includes at least conductor 360a.

The set of conductors 360 overlaps at least one of the set of active regions 302 or 304, the set of contacts 306, 307 or 308 or the set of conductors 330, 332, 340 or 350.

In some embodiments, conductor 360a is electrically coupled to at least one of conductors 330a, 330c or 330e by at least conductor 340a or conductor 350a, and is configured to supply the supply voltage VDD, and is thus referred to as an “M3 VDD strap.”

In some embodiments, at least one conductor of the set of conductors 350 is electrically coupled to at least one of conductors 330b, 330d or 330f by at least conductor 340b or conductor 350a, and is configured to supply the reference supply voltage VSS, and is thus referred to as an “M3 VSS strap.”

In some embodiments, the set of conductors 360 corresponds to 1 M3 routing track. Other numbers or positions of M3 routing tracks are within the scope of the present disclosure.

Other configurations, arrangements on other layout levels or quantities of conductors in the set of conductors 360 are within the scope of the present disclosure.

The set of vias 362 includes one or more of via 362a.

In some embodiments, the set of vias 362 is between the set of conductors 360 and the set of conductors 350.

Via 362a is between conductor 360a and conductor 350a.

The set of vias 362 is configured to electrically couple one or more conductors of the set of conductors 360 to one or more conductors of the set of conductors 350, and vice versa.

Via 362a is configured to electrically couple conductor 360a and conductor 350a together.

Other configurations, arrangements on other layout levels or quantities of vias in at least set of vias 362 are within the scope of the present disclosure.

In some embodiments, by including at least one or more of the set of conductors 340, the set of vias 342, the set of conductors 350, the set of vias 352, the set of vias 362 or the set of conductors 360, integrated circuit 300 has less resistance than other approaches thereby improving performance.

In some embodiments, at least one contact of the set of contacts 306, 307 or 308, or at least one conductor of the set of conductors 330, 332, 340, 350 or 360, or at least one via of the set of vias 320, 342, 352, 362, 520 or 620 includes one or more layers of a conductive material, a metal, a metal compound or a doped semiconductor. In some embodiments, the conductive material includes Tungsten, Cobalt, Ruthenium, Copper, or the like or combinations thereof. In some embodiments, a metal includes at least Cu (Copper), Co, W, Ru, Al, Ti, Ta, TiN, TaN, NiSi, CoSi, other suitable conductive materials, or combinations thereof. In some embodiments, a metal compound includes at least AlCu, W-TIN, TiSix, NiSix, TiN, TaN, or the like. In some embodiments, a doped semiconductor includes at least doped silicon, or the like.

Other configurations or arrangements of integrated circuit 300 are within the scope of the present disclosure.

FIGS. 4A-4B are corresponding diagrams of an integrated circuit 400, in accordance with some embodiments.

Integrated circuit 400 is manufactured by a corresponding layout design similar to integrated circuit 400. For brevity FIGS. 4A-10B are described as a corresponding integrated circuit 400-1000, but in some embodiments, FIGS. 4A-10B also correspond to layout designs similar to layout designs 100A-100B or 200, structural elements of integrated circuit 400-1000 also correspond to layout patterns, and structural relationships including alignment, lengths and widths, as well as configurations and layers of a corresponding layout design of integrated circuit 400-1000 are similar to the structural relationships and configurations and layers of integrated circuit 400-1000, and similar detailed description will not be described for brevity.

In some embodiments, at least integrated circuit 400, 500, 600, 700, 800, 900 or 1000 is manufactured by a layout design similar to at least one of layout design 200, and similar detailed description is therefore omitted. Structural relationships including alignment, lengths and widths, as well as configurations and layers of at least integrated circuit 400, 500, 600, 700, 800, 900 or 1000 are similar to the structural relationships and configurations and layers of integrated circuit 300 of FIGS. 3A-3G, and similar detailed description will not be described in at least FIGS. 4A-10B, for brevity.

Integrated circuit 400 is a variation of integrated circuit 300 (FIGS. 3A-3G), and similar detailed description is therefore omitted.

Integrated circuit 400 includes at least one or more of the set of active regions 302 and 304, the set of contacts 306, the set of contacts 307, the set of contacts 308, the set of conductors 330, the set of conductors 332, the set of vias 320, the substrate 380, the insulating region 382, the set of cells 310, the set of cells 311 or the set of cells 312.

In comparison with integrated circuit 300 of FIGS. 3A-3G, integrated circuit 400 does not include the set of conductors 340, the set of vias 342, the set of conductors 350, the set of vias 352, the set of conductors 360 and the set of vias 362, and similar detailed description is therefore omitted. In some embodiments, by not including the set of conductors 340, the set of vias 342, the set of conductors 350, the set of vias 352, the set of conductors 360 and the set of vias 362, integrated circuit 400 occupies less area than other approaches.

In some embodiments, integrated circuit 400 achieves one or more of the benefits discussed herein.

Other configurations or arrangements of integrated circuit 400 are within the scope of the present disclosure.

FIGS. 5A-5B are corresponding diagrams of an integrated circuit 500, in accordance with some embodiments.

Integrated circuit 500 is manufactured by a corresponding layout design similar to integrated circuit 500.

Integrated circuit 500 is a variation of integrated circuit 300 (FIGS. 3A-3G) or integrated circuit 400 (FIGS. 4A-4B), and similar detailed description is therefore omitted. In comparison with integrated circuit 400 of FIGS. 4A-4B, integrated circuit 500 includes a different number of cells in the set of cells 512 or a different number of vias in the set of vias 520, and similar detailed description is therefore omitted.

Integrated circuit 500 includes at least one or more of the set of active regions 302 and 304, the set of contacts 306, the set of contacts 307, the set of contacts 308, a set of vias 520, the set of conductors 330, the set of conductors 332, the substrate 380, the insulating region 382, the set of cells 310, the set of cells 311 or a set of cells 512.

In comparison with integrated circuit 400 of FIGS. 4A-4B, the set of cells 512 of integrated circuit 500 replaces the set of cells 312, and the set of vias 520 of integrated circuit 500 replaces the set of vias 320, and similar detailed description is therefore omitted.

The set of cells 512 includes one or more of cells 312a, 312b, 512a or 512b.

In comparison with integrated circuit 300 of FIGS. 3A-3G, cell 512a is similar to cell 312a, cell 512b is similar to cell 312b, and similar detailed description is therefore omitted.

Cell 512a includes a via 520a.

Cell 512b includes a via 520b.

The set of vias 520 includes at least one of via 320a, 320b, via 520a or 520b.

In comparison with integrated circuit 300 of FIGS. 3A-3G, via 520a is similar to via 320a, via 520b is similar to via 320b, and similar detailed description is therefore omitted.

Via 520a is between conductor 330e and conductor 332e. Via 520a is configured to electrically couple conductor 330e and conductor 332e together. In some embodiments, via 520a is configured to supply the supply voltage VDD from the back-side 303b of integrated circuit 300, 400, 500, 600, 700, 800, 900 or 1000 to the front-side 303a. For example, in some embodiments, via 520a is configured to supply the supply voltage VDD from conductor 332e to the conductor 330e.

Via 520b is between conductor 330d and conductor 332d. Via 520b is configured to electrically couple conductor 330d and conductor 332d together. In some embodiments, via 520b is configured to supply the reference voltage VSS from the back-side 303b of integrated circuit 300, 400, 500, 600, 700, 800, 900 or 1000 to the front-side 303a. For example, in some embodiments, via 520b is configured to supply the reference voltage VSS from conductor 332d to the conductor 330d.

In some embodiments, the set of vias 520 are positioned adjacent or directly next to the set of cells 211. In some embodiments, the set of vias 520 are positioned adjacent or directly next to the set of cells 211 thereby further reducing resistance from the set of conductors 330 or 332, by reducing the distance between the set of cells 211 and the corresponding supply voltage VDD or reference supply voltage VSS. In some embodiments, integrated circuit 500 has lower resistance than other approaches thereby improving performance.

In some embodiments, integrated circuit 500 achieves one or more of the benefits discussed herein.

Other configurations or arrangements of integrated circuit 500 are within the scope of the present disclosure.

FIGS. 6A-6B are corresponding diagrams of an integrated circuit 600, in accordance with some embodiments.

Integrated circuit 600 is manufactured by a corresponding layout design similar to integrated circuit 600.

Integrated circuit 600 is a variation of integrated circuit 300 (FIGS. 3A-3G) or integrated circuit 400 (FIGS. 4A-4B), and similar detailed description is therefore omitted. In comparison with integrated circuit 400 of FIGS. 4A-4B, integrated circuit 600 includes different positions for the set of cells 612 or different positions for the set of vias 620, and similar detailed description is therefore omitted.

Integrated circuit 600 includes at least one or more of the set of active regions 302 and 304, the set of contacts 306, the set of contacts 307, the set of contacts 308, a set of vias 620, the set of conductors 330, the set of conductors 332, the substrate 380, the insulating region 382, the set of cells 310, the set of cells 311 or a set of cells 612.

In comparison with integrated circuit 400 of FIGS. 4A-4B, the set of cells 612 of integrated circuit 600 replaces the set of cells 312, and the set of vias 620 of integrated circuit 600 replaces the set of vias 320, and similar detailed description is therefore omitted.

The set of cells 612 includes one or more of cells 612a or 612b.

In comparison with integrated circuit 300 of FIGS. 3A-3G, cell 612a is similar to cell 312b, cell 612b is similar to cell 312a, and similar detailed description is therefore omitted.

Cell 612a includes a via 620a.

Cell 612b includes a via 620b.

The set of vias 620 includes at least one of via 620a or 620b.

In comparison with integrated circuit 300 of FIGS. 3A-3G, via 620a is similar to via 320b, via 620b is similar to via 320a, and similar detailed description is therefore omitted.

Via 620a is adjacent to cell 311b. Via 620a is between conductor 330d and conductor 332d. Via 620a is configured to electrically couple conductor 330d and conductor 332d together. In some embodiments, via 620a is configured to supply the reference voltage VSS from the back-side 303b of integrated circuit 300, 400, 600, 600, 700, 800, 900 or 1000 to the front-side 303a. For example, in some embodiments, via 620a is configured to supply the reference voltage VSS from conductor 332d to the conductor 330d.

Via 620b is adjacent to cell 311a. Via 620b is between conductor 330e and conductor 332e. Via 620b is configured to electrically couple conductor 330e and conductor 332e together. In some embodiments, via 620b is configured to supply the supply voltage VDD from the back-side 303b of integrated circuit 300, 400, 600, 600, 700, 800, 900 or 1000 to the front-side 303a. For example, in some embodiments, via 620b is configured to supply the supply voltage VDD from conductor 332e to the conductor 330e.

In some embodiments, the set of vias 620 are positioned adjacent or directly next to the set of cells 211. In some embodiments, the set of vias 620 are positioned adjacent or directly next to the set of cells 211 thereby reducing resistance from the set of conductors 330 or 332, by reducing the distance between the set of cells 211 and the corresponding supply voltage VDD or reference supply voltage VSS. In some embodiments, integrated circuit 600 has lower resistance than other approaches thereby improving performance.

In some embodiments, integrated circuit 600 achieves one or more of the benefits discussed herein.

Other configurations or arrangements of integrated circuit 600 are within the scope of the present disclosure.

FIGS. 7A-7B are corresponding diagrams of an integrated circuit 700, in accordance with some embodiments.

Integrated circuit 700 is manufactured by a corresponding layout design similar to integrated circuit 700.

Integrated circuit 700 is a variation of integrated circuit 300 (FIGS. 3A-3G) or integrated circuit 400 (FIGS. 4A-4B), and similar detailed description is therefore omitted.

Integrated circuit 700 includes at least one or more of the set of active regions 302 and 304, the set of contacts 306, the set of contacts 307, the set of contacts 308, the set of conductors 330, the set of conductors 332, the substrate 380, the insulating region 382, the set of cells 310 or the set of cells 311.

In comparison with integrated circuit 400 of FIGS. 4A-4B, integrated circuit 700 does not include the set of vias 320 and the set of cells 312, and similar detailed description is therefore omitted. In some embodiments, by not including the set of vias 320 and the set of cells 312, integrated circuit 700 occupies less area than other approaches.

In some embodiments, integrated circuit 700 achieves one or more of the benefits discussed herein.

Other configurations or arrangements of integrated circuit 700 are within the scope of the present disclosure.

FIGS. 8A-8B are corresponding diagrams of an integrated circuit 800, in accordance with some embodiments.

Integrated circuit 800 is manufactured by a corresponding layout design similar to integrated circuit 800.

Integrated circuit 800 is a variation of integrated circuit 300 (FIGS. 3A-3G) or integrated circuit 700 (FIGS. 7A-7B), and similar detailed description is therefore omitted. In comparison with integrated circuit 700 of FIGS. 7A-7B, integrated circuit 800 has rows of different heights (e.g., H1 and H2) and similar detailed description is therefore omitted. In comparison with integrated circuit 700 of FIGS. 7A-7B, integrated circuit 800 includes a different pitch for conductors 330d-330f and 332d-332f compared with corresponding conductors 330a-330c and 332a-332c, and similar detailed description is therefore omitted.

Integrated circuit 800 is manufactured by layout design 100B, and similar detailed description is therefore omitted. Integrated circuit 800 includes rows of height H1 and height H2.

Integrated circuit 800 includes at least one or more of the set of active regions 302 and 304, the set of contacts 306, the set of contacts 307, the set of contacts 308, the set of vias 320, the set of conductors 330, the set of conductors 332, the substrate 380, the insulating region 382, the set of cells 310, the set of cells 311 or the set of cells 312.

In comparison with integrated circuit 700 of FIGS. 7A-7B, rows 4 and 5 of integrated circuit 800 have a height H2, and similar detailed description is therefore omitted. In some embodiments, since rows 4 and 5 have a height H2 that is different from a height H1 of rows 1-3, integrated circuit 800 has a hybrid row design that includes at least two rows with different heights.

In comparison with integrated circuit 700 of FIGS. 7A-7B, conductors 330d-330f of integrated circuit 800 have a pitch P2a, and conductors 332d-332f of integrated circuit 800 have a pitch P2b, and similar detailed description is therefore omitted.

In some embodiments, pitch P2a is different from pitch P1a′.

In some embodiments, pitch P2b is different from pitch P1b′.

In some embodiments, since conductors 330d-330f have a pitch P2a different from pitch P1a′ of conductors 330a-330c, rows 4-5 of integrated circuit 800 have a height H2 that is different from the height H1 of rows 1-5 of integrated circuit 800, and integrated circuit 800 has a hybrid row height.

In some embodiments, conductors 332-332f have a pitch P2b different from pitch P1b′ of conductors 332a-332c, rows 4-5 of integrated circuit 800 have a height H2 that is different from the height H1 of rows 1-5 of integrated circuit 800, and integrated circuit 800 has a hybrid row height. In some embodiments, by having a hybrid row height, integrated circuit 800 occupies less area than other approaches.

In some embodiments, integrated circuit 800 achieves one or more of the benefits discussed herein.

Other configurations or arrangements of integrated circuit 800 are within the scope of the present disclosure.

FIGS. 9A-9B are corresponding diagrams of an integrated circuit 900, in accordance with some embodiments.

Integrated circuit 900 is manufactured by a corresponding layout design similar to integrated circuit 900.

Integrated circuit 900 is a variation of integrated circuit 300 (FIGS. 3A-3G) or integrated circuit 400 (FIGS. 4A-4B) or integrated circuit 800 (FIGS. 8A-8B), and similar detailed description is therefore omitted. For example, integrated circuit 900 combines the features of integrated circuit 400 (FIGS. 4A-4B) with the hybrid row height of integrated circuit 800 (FIGS. 8A-8B), and similar detailed description is therefore omitted. In comparison with integrated circuit 400 of FIGS. 4A-4B, integrated circuit 900 has rows of different heights (e.g., H1 and H2) and similar detailed description is therefore omitted. In comparison with integrated circuit 400 of FIGS. 4A-4B, integrated circuit 900 includes a different pitch for conductors 330d-330f and 332d-332f compared with corresponding conductors 330a-330c and 332a-332c, and similar detailed description is therefore omitted.

Integrated circuit 900 includes rows of height H1 and height H2.

In some embodiments, by having a hybrid row height, integrated circuit 900 occupies less area than other approaches.

In some embodiments, integrated circuit 900 achieves one or more of the benefits discussed herein.

Other configurations or arrangements of integrated circuit 900 are within the scope of the present disclosure.

FIGS. 10A-10B are corresponding diagrams of an integrated circuit 1000, in accordance with some embodiments.

Integrated circuit 1000 is manufactured by a corresponding layout design similar to integrated circuit 1000.

Integrated circuit 1000 is a variation of integrated circuit 300 (FIGS. 3A-3G) or integrated circuit 800 (FIGS. 8A-8B), and similar detailed description is therefore omitted. For example, integrated circuit 1000 combines the features of integrated circuit 300 (FIGS. 3A-3G) with the hybrid row height of integrated circuit 800 (FIGS. 8A-8B), and similar detailed description is therefore omitted. In comparison with integrated circuit 300 (FIGS. 3A-3G), integrated circuit 1000 has rows of different heights (e.g., H1 and H2) and similar detailed description is therefore omitted. In comparison with integrated circuit 300 (FIGS. 3A-3G), integrated circuit 1000 includes a different pitch for conductors 330d-330f and 332d-332f compared with corresponding conductors 330a-330c and 332a-332c, and similar detailed description is therefore omitted.

Integrated circuit 1000 includes rows of height H1 and height H2.

In some embodiments, by having a hybrid row height, integrated circuit 1000 occupies less area than other approaches.

In some embodiments, integrated circuit 1000 achieves one or more of the benefits discussed herein.

Other configurations or arrangements of integrated circuit 1000 are within the scope of the present disclosure.

FIGS. 11A-11B are functional flow charts of corresponding methods 1100A-1100B of manufacturing an IC device, in accordance with some embodiments. It is understood that additional operations may be performed before, during, and/or after the method 1100A-1100B depicted in FIGS. 11A-11B, and that some other processes may only be briefly described herein.

In some embodiments, other order of operations of method 1100A-1300 is within the scope of the present disclosure. Method 1100A-1300 includes exemplary operations, but the operations are not necessarily performed in the order shown. Operations may be added, replaced, changed order, and/or eliminated as appropriate, in accordance with the spirit and scope of disclosed embodiments. In some embodiments, one or more of the operations of at least method 1100A, 1100B, 1200 or 1300 is not performed.

In some embodiments, method 1100A-1100B is an embodiment of operation 1204 of method 1200. In some embodiments, the methods 1100A-1300 are usable to manufacture or fabricate at least integrated circuit 300, 400, 500, 600, 700, 800, 900 or 1000, or an integrated circuit with similar features as at layout design 100A, 100B or 200.

In operation 1102 of method 1100A, a first set of transistors and a second set of transistors are fabricated on a front-side 303a of a semiconductor wafer or substrate. In some embodiments, the first set of transistors of method 1100A-1100B includes one or more transistors in at least the set of active regions 302. In some embodiments, the second set of transistors of method 1100A-1100B includes one or more transistors in at least the set of active regions 304. In some embodiments, the first set of transistors or the second set of transistors of method 1100A-1100B includes one or more transistors described herein.

In some embodiments, operation 1102 further includes fabricating source and drain regions of the set of transistors in a first well. In some embodiments, the first well comprises p-type dopants. In some embodiments, the p-dopants include boron, aluminum or other suitable p-type dopants. In some embodiments, the first well comprises an epi-layer grown over a substrate. In some embodiments, the epi-layer is doped by adding dopants during the epitaxial process. In some embodiments, the epi-layer is doped by ion implantation after the epi-layer is formed. In some embodiments, the first well is formed by doping the substrate. In some embodiments, the doping is performed by ion implantation. In some embodiments, the first well has a dopant concentration ranging from 1×10¹² atoms/cm³ to 1×10¹⁴ atoms/cm³.

In some embodiments, the first well comprises n-type dopants. In some embodiments, the n-type dopants include phosphorus, arsenic or other suitable n-type dopants. In some embodiments, the n-type dopant concentration ranges from about 1×10¹² atoms/cm³ to about 1×10¹⁴ atoms/cm³.

In some embodiments, the formation of the source/drain features includes, a portion of the substrate is removed to form recesses at an edge of spacers, and a filling process is then performed by filling the recesses in the substrate. In some embodiments, the recesses are etched, for example, a wet etching or a dry etching, after removal of a pad oxide layer or a sacrificial oxide layer. In some embodiments, the etch process is performed to remove a top surface portion of the active region adjacent to an isolation region, such as an STI region. In some embodiments, the filling process is performed by an epitaxy or epitaxial (epi) process. In some embodiments, the recesses are filled using a growth process which is concurrent with an etch process where a growth rate of the growth process is greater than an etch rate of the etch process. In some embodiments, the recesses are filled using a combination of growth process and etch process. For example, a layer of material is grown in the recess and then the grown material is subjected to an etch process to remove a portion of the material. Then a subsequent growth process is performed on the etched material until a desired thickness of the material in the recess is achieved. In some embodiments, the growth process continues until a top surface of the material is above the top surface of the substrate. In some embodiments, the growth process is continued until the top surface of the material is co-planar with the top surface of the substrate. In some embodiments, a portion of the first well is removed by an isotropic or an anisotropic etch process. The etch process selectively etches the first well without etching a gate structure and any spacers. In some embodiments, the etch process is performed using a reactive ion etch (RIE), wet etching, or other suitable techniques. In some embodiments, a semiconductor material is deposited in the recesses to form the source/drain features. In some embodiments, an epi process is performed to deposit the semiconductor material in the recesses. In some embodiments, the epi process includes a selective epitaxy growth (SEG) process, CVD process, molecular beam epitaxy (MBE), other suitable processes, and/or combination thereof. The epi process uses gaseous and/or liquid precursors, which interact with a composition of substrate. In some embodiments, the source/drain features include epitaxially grown silicon (epi Si), silicon carbide, or silicon germanium. Source/drain features of the IC device associated with the gate structure are in-situ doped or undoped during the epi process in some instances. When source/drain features are undoped during the epi process, source/drain features are doped during a subsequent process in some instances. The subsequent doping process is achieved by an ion implantation, plasma immersion ion implantation, gas and/or solid source diffusion, other suitable processes, and/or combination thereof. In some embodiments, source/drain features are further exposed to annealing processes after forming source/drain features and/or after the subsequent doping process.

In some embodiments, operation 1102 further includes operation 1102a. In some embodiments, operation 1102a includes forming a first active region of the first set of transistors. In some embodiments, the first active region of the first set of transistors of method 1100A-1100B includes the set of active regions 302.

In some embodiments, operation 1102 further includes operation 1102b. In some embodiments, operation 1102b includes forming a second active region of the second set of transistors. In some embodiments, the second active regions of the second set of transistors of method 1100A-1100B includes the set of active regions 304.

In some embodiments, operation 1102 further includes operation 1102c. In some embodiments, operation 1102c includes depositing a first conductive material on at least one of a first level or a second level thereby forming at least one of a corresponding first set of contacts or a second set of contacts. In some embodiments, the first level is the MD level. In some embodiments, the second level is the BMD level.

In some embodiments, the first set of contacts and the second set of contacts are part of the first set of transistors and the second set of transistors.

In some embodiments, the first set of contacts includes the set of contacts 306 or 308.

In some embodiments, the second set of contacts includes the set of contacts 307.

In operation 1103a of method 1100B, at least a first set of conductors on the front-side of the substrate is electrically coupled to at least the first set of transistors or the second set of transistors.

In some embodiments, the first set of conductors on the front-side of the substrate of method 1100A-1100B includes one or more conductors of the set of conductors 330.

In operation 1103b of method 1100B, at least a second set of conductors on the back-side of the substrate is electrically coupled to at least the first set of transistors.

In some embodiments, the second set of conductors on the back-side of the substrate of method 1100A-1100B includes one or more conductors of the set of conductors 332.

FIG. 11B is a functional flow chart of a method 1100B of manufacturing an IC device, in accordance with some embodiments. It is understood that additional operations may be performed before, during, and/or after the method 1100B depicted in FIG. 11B, and that some other processes may only be briefly described herein.

In some embodiments, method 1100B is an embodiment of operations 1103a and 1103b of method 1100A, and similar detailed description is therefore omitted.

In operation 1104 of method 1100B, a first set of vias are formed on the front-side 303a of a wafer or substrate on a VD level (e.g., VD). In some embodiments, the first set of vias of method 1100B includes one or more portions at least the set of vias 370 or 372.

In some embodiments, operation 1104 includes forming a first set of self-aligned contacts (SACs) in the insulating layer over the front-side 303a of the wafer. In some embodiments, the first set of vias is electrically coupled to at least the first set of transistors.

In operation 1106 of method 1100B, a second conductive material is deposited on the front-side 303a of the substrate on a first metal level thereby forming a first set of conductors on the front-side 303a of the wafer or substrate on a first metal level (e.g., M0).

In some embodiments, operation 1106 includes at least depositing a first set of conductive regions over the front-side 303a of the integrated circuit. In some embodiments, the first set of conductors of method 1100B includes one or more portions of at least the set of conductors 330.

In some embodiments, operation 1106 is an embodiment of operation 1103a, and similar detailed description is therefore omitted.

In operation 1108 of method 1100B, thinning is performed on the back-side 303b of the wafer or substrate. In some embodiments, operation 1108 includes a thinning process performed on the back-side 303b of the semiconductor wafer or substrate. In some embodiments, the thinning process includes a grinding operation and a polishing operation (such as chemical mechanical polishing (CMP)) or other suitable processes. In some embodiments, after the thinning process, a wet etching operation is performed to remove defects formed on the back-side 303b of the semiconductor wafer or substrate.

In operation 1110 of method 1100B, a third conductive material is deposited on the back-side 303b of the substrate on a second metal level thereby forming a second set of conductors on the back-side 303b of the wafer or substrate on a second metal level (e.g., BM0).

In some embodiments, operation 1110 includes at least depositing a second set of conductive regions over the back-side 303b of the integrated circuit. In some embodiments, the second set of conductors of method 1100B includes one or more portions of at least the set of conductors 332.

In some embodiments, operation 1110 is an embodiment of operation 1103b, and similar detailed description is therefore omitted.

In operation 1112 of method 1100B, a second set of vias are formed.

In operation 1112 of method 1100B, the second set of vias are formed on the back-side 303b of the thinned wafer or substrate on a V0 level (e.g., V0). In operation 1112 of method 1100B, the second set of vias are formed in the thinned wafer or substrate on an FTV level (e., FTV).

In some embodiments, the second set of vias of method 1100B includes one or more portions at least the set of vias 342. In some embodiments, the second set of vias of method 1100B includes one or more portions at least the set of vias 320, 520 or 620.

In some embodiments, operation 1112 includes forming a second set of SACs in the insulating layer over the back-side 303b of the wafer. In some embodiments, the second set of vias is electrically coupled to at least the first set of transistors or the second set of transistors.

In operation 1114 of method 1100B, a fourth conductive material is deposited on the front-side 303a of the substrate on a third metal level thereby forming a third set of conductors on the front-side 303a of the wafer or substrate on a third metal level (e.g., M1).

In some embodiments, operation 1114 includes at least depositing a third set of conductive regions over the front-side 303a of the integrated circuit. In some embodiments, the third set of conductors of method 1100B includes one or more portions of at least the set of conductors 340.

In operation 1116 of method 1100B, a third set of vias are formed on the front-side 303a of the wafer or substrate on a V1 level (e.g., V1). In some embodiments, the third set of vias of method 1100B includes one or more portions of at least the set of vias 352.

In some embodiments, operation 1116 includes forming a third set of SACs in the insulating layer over the front-side 303a of the wafer. In some embodiments, the third set of vias is electrically coupled to at least the first set of transistors.

In operation 1118 of method 1100B, a fifth conductive material is deposited on the back-side 303b of the substrate on a fourth metal level thereby forming a fourth set of conductors on the back-side 303b of the wafer or substrate on a fourth metal level (e.g., M2).

In some embodiments, operation 1118 includes at least depositing a fourth set of conductive regions over the back-side 303b of the integrated circuit. In some embodiments, the fourth set of conductors of method 1100B includes one or more portions of at least the set of conductors 350.

In operation 1120 of method 1100B, a fourth set of vias are formed on the back-side 303b of the thinned wafer or substrate on a V2 level (e.g., V2). In some embodiments, the fourth set of vias of method 1100B includes one or more portions at least the set of vias 362.

In some embodiments, operation 1120 includes forming a fourth set of SACs in the insulating layer over the back-side 303b of the wafer. In some embodiments, the fourth set of vias is electrically coupled to at least the first set of transistors or the second set of transistors.

In operation 1124 of method 1100B, a sixth conductive material is deposited on the front-side 303a of the substrate on a fifth metal level thereby forming a fifth set of conductors on the front-side 303a of the wafer or substrate on a fifth metal level (e.g., M3).

In some embodiments, operation 1124 includes at least depositing a fifth set of conductive regions over the front-side 303a of the integrated circuit. In some embodiments, the fifth set of conductors of method 1100B includes one or more portions of at least the set of conductors 360.

In some embodiments, one or more of operations 1102, 1103a, 1103b, 1104, 1106, 1110, 1112, 1114, 1116, 1118, 1120, 1122 or 1124 of methods 1100A-1100B include using a combination of photolithography and material removal processes to form openings in an insulating layer (not shown) over the substrate. In some embodiments, the photolithography process includes patterning a photoresist, such as a positive photoresist or a negative photoresist. In some embodiments, the photolithography process includes forming a hard mask, an antireflective structure, or another suitable photolithography structure. In some embodiments, the material removal process includes a wet etching process, a dry etching process, an RIE process, laser drilling or another suitable etching process. The openings are then filled with conductive material, e.g., copper, aluminum, titanium, nickel, tungsten, or other suitable conductive material. In some embodiments, the openings are filled using CVD, PVD, sputtering, ALD or other suitable formation process.

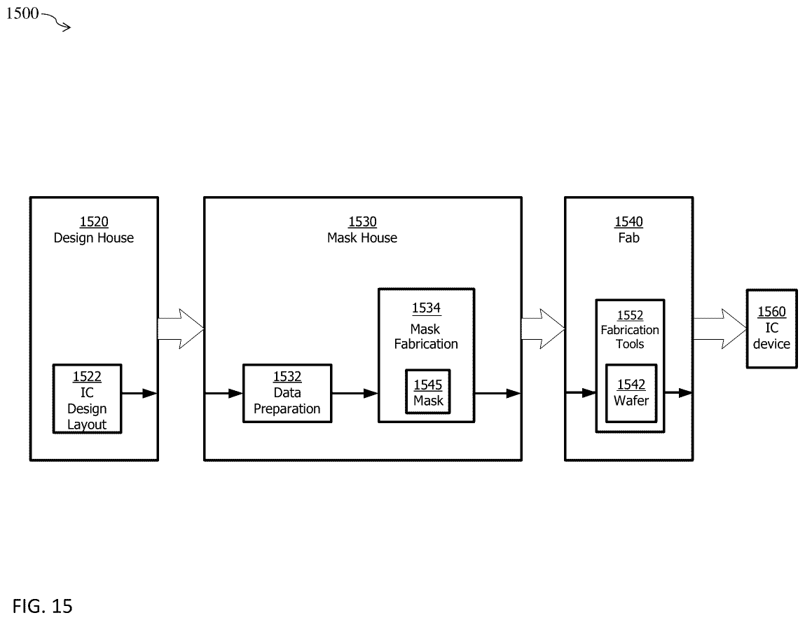

In some embodiments, at least one or more operations of method 1100A-1100B is performed by system 1500 of FIG. 15. In some embodiments, at least one method(s), such as method 1100A-1100B discussed above, is performed in whole or in part by at least one manufacturing system, including system 1500. One or more of the operations of method 1100A-1100B is performed by IC fab 1540 (FIG. 15) to fabricate IC device 1560. In some embodiments, one or more of the operations of method 1100A-1100B is performed by fabrication tools 1552 to fabricate wafer 1542.

In some embodiments, the conductive material includes copper, aluminum, titanium, nickel, tungsten, or other suitable conductive material. In some embodiments, the openings and trench are filled using CVD, PVD, sputtering, ALD or other suitable formation process. In some embodiments, after conductive material is deposited in one or more of operations 1102c, 1106, 1110, 1114, 1118 or 1122, the conductive material is planarized to provide a level surface for subsequent steps.

In some embodiments, one or more of the operations of method 1100A, 1100B, 1200 or 1300 is not performed.

One or more of the operations of methods 1200-1300 is performed by a processing device configured to execute instructions for manufacturing an integrated circuit, such as at least integrated circuit 300, 400, 500, 600, 700, 800, 900 or 1000. In some embodiments, one or more operations of methods 1200-1300 is performed using a same processing device as that used in a different one or more operations of methods 1200-1300. In some embodiments, a different processing device is used to perform one or more operations of methods 1200-1300 from that used to perform a different one or more operations of methods 1200-1300. In some embodiments, other order of operations of method 1100A, 1100B, 1200 or 1300 is within the scope of the present disclosure. Method 1100A, 1100B, 1200 or 1300 includes exemplary operations, but the operations are not necessarily performed in the order shown. Operations in method 1100A, 1100B, 1200 or 1300 may be added, replaced, changed order, and/or eliminated as appropriate, in accordance with the spirit and scope of disclosed embodiments.

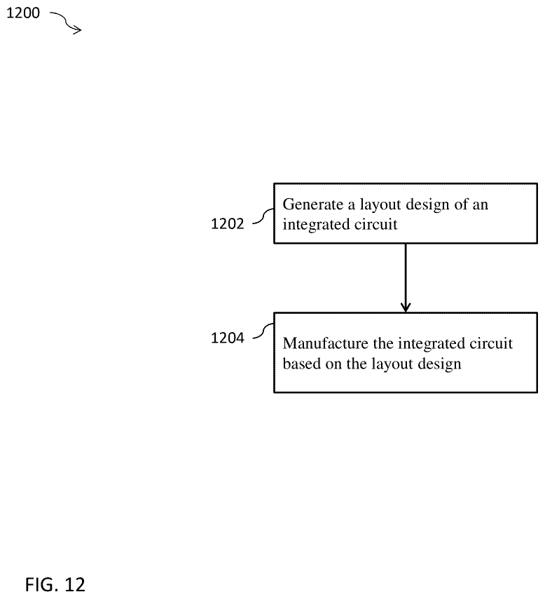

FIG. 12 is a flowchart of a method 1200 of forming or manufacturing an integrated circuit in accordance with some embodiments. It is understood that additional operations may be performed before, during, and/or after the method 1200 depicted in FIG. 12, and that some other operations may only be briefly described herein. In some embodiments, the method 1200 is usable to form integrated circuits, such as at least integrated circuit 300, 400, 500, 600, 700, 800, 900 or 1000. In some embodiments, the method 1200 is usable to form integrated circuits having similar features and similar structural relationships as one or more of layout design 100A, 100B or 200.

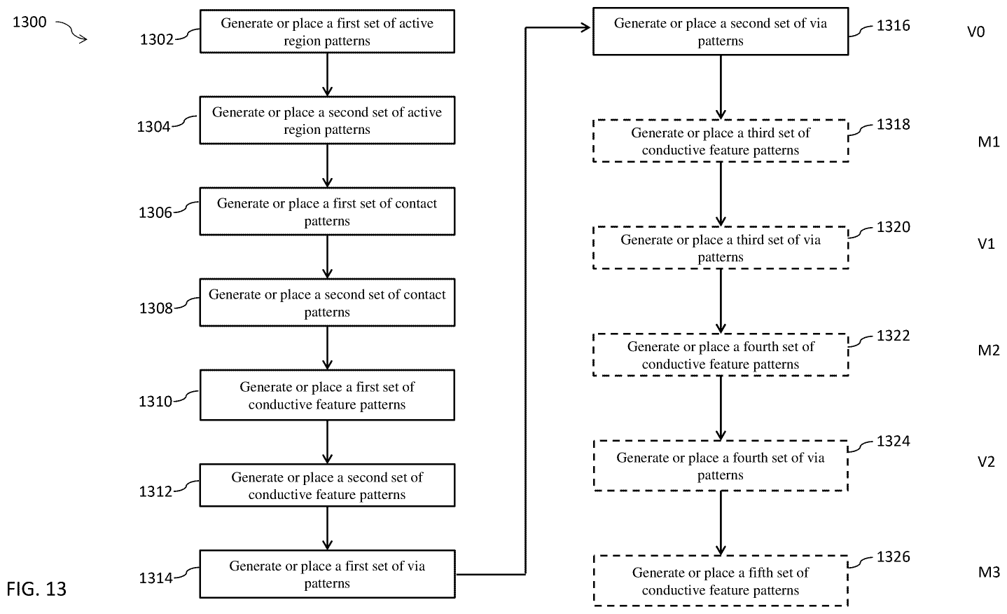

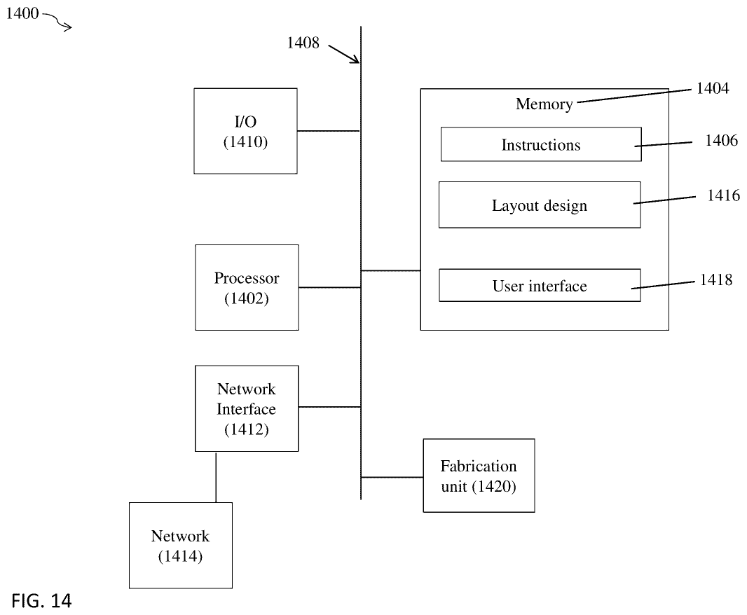

In operation 1202 of method 1200, a layout design of an integrated circuit is generated. Operation 1202 is performed by a processing device (e.g., processor 1402 (FIG. 14)) configured to execute instructions for generating a layout design. In some embodiments, the layout design of method 1200 includes one or more patterns of at layout design 100A, 100B or 200, or one or more features similar to at least integrated circuit 300, 400, 500, 600, 700, 800, 900 or 1000. In some embodiments, the layout design of the present application is in a graphic database system (GDSII) file format. In some embodiments, operation 1202 corresponds to method 1300 of FIG. 13.

In operation 1204 of method 1200, the integrated circuit is manufactured based on the layout design. In some embodiments, operation 1204 of method 1200 comprises manufacturing at least one mask based on the layout design, and manufacturing the integrated circuit based on the at least one mask. In some embodiments, operation 1204 corresponds to method 1100 of FIG. 11.

FIG. 13 is a flowchart of a method 1300 of generating a layout design of an integrated circuit, in accordance with some embodiments. It is understood that additional operations may be performed before, during, and/or after the method 1300 depicted in FIG. 13, and that some other processes may only be briefly described herein. In some embodiments, method 1300 is an embodiment of operation 1202 of method 1200. In some embodiments, method 1300 is usable to generate one or more layout patterns of at layout design 100A, 100B or 200, or one or more features similar to at least integrated circuit 300, 400, 500, 600, 700, 800, 900 or 1000.

In some embodiments, method 1300 is usable to generate one or more layout patterns having structural relationships including alignment, lengths and widths, as well as configurations and layers of at layout design 100A, 100B or 200, or one or more features similar to at least integrated circuit 300, 400, 500, 600, 700, 800, 900 or 1000, and similar detailed description will not be described in FIG. 13, for brevity.

In operation 1302 of method 1300, a first set of active region patterns is generated or placed on the layout design. In some embodiments, the first set of active region patterns of method 1300 includes at least portions of one or more patterns of the set of active region patterns 202. In some embodiments, the first set of active region patterns of method 1300 includes one or more regions similar to the set of active regions 302. In some embodiments, the first set of active region patterns of method 1300 includes one or more patterns or similar patterns in the OD layer.

In operation 1304 of method 1300, a second set of active region patterns is generated or placed on the layout design. In some embodiments, the second set of active region patterns of method 1300 includes at least portions of one or more patterns of the set of active region patterns 204. In some embodiments, the second set of active region patterns of method 1300 includes one or more regions similar to the set of active regions 304. In some embodiments, the second set of active region patterns of method 1300 includes one or more patterns or similar patterns in the OD layer.

In operation 1306 of method 1300, a first set of contact patterns is generated or placed on the layout design. In some embodiments, the first set of contact patterns of method 1300 includes at least portions of one or more patterns of the set of contact patterns 206 or 208. In some embodiments, the first set of contact patterns of method 1300 includes one or more patterns similar to the set of contacts 306 or 308. In some embodiments, the first set of contact patterns of method 1300 includes one or more patterns or similar patterns in the MD layer.

In operation 1308 of method 1300, a second set of contact patterns is generated or placed on the layout design. In some embodiments, the second set of contact patterns of method 1300 includes at least portions of one or more patterns of the set of contact patterns 207. In some embodiments, the second set of contact patterns of method 1300 includes one or more patterns similar to the set of contacts 307. In some embodiments, the second set of contact patterns of method 1300 includes one or more patterns or similar patterns in the BMD layer.

In operation 1310 of method 1300, a first set of conductive feature patterns is generated or placed on the layout design. In some embodiments, the first set of conductive feature patterns of method 1300 includes at least portions of one or more patterns of the set of conductive feature patterns 230. In some embodiments, the first set of conductive feature patterns of method 1300 includes one or more patterns similar to the set of conductors 330. In some embodiments, the first set of conductive feature patterns of method 1300 includes one or more patterns or similar patterns in the M0 layer.

In operation 1312 of method 1300, a second set of conductive feature patterns is generated or placed on the layout design. In some embodiments, the second set of conductive feature patterns of method 1300 includes at least portions of one or more patterns of the set of conductive feature patterns 232. In some embodiments, the second set of conductive feature patterns of method 1300 includes one or more patterns similar to the set of conductors 332. In some embodiments, the second set of conductive feature patterns of method 1300 includes one or more patterns or similar patterns in the BM0 layer.

In operation 1314 of method 1300, a first set of via patterns is generated or placed on the layout design. In some embodiments, the first set of via patterns of method 1300 includes at least portions of one or more patterns of the set of via patterns 220. In some embodiments, the first set of via patterns of method 1300 includes at least portions of one or more patterns of the set of cells 212. In some embodiments, the first set of via patterns of method 1300 includes one or more via patterns similar to at least the set of vias 320, 520 or 620. In some embodiments, the first set of via patterns of method 1300 includes one or more via patterns similar to at least the set of cells 312. In some embodiments, the first set of via patterns of method 1300 includes one or more patterns or similar vias in the FTV layer.

In operation 1316 of method 1300, a second set of via patterns is generated or placed on the layout design. In some embodiments, the second set of via patterns of method 1300 includes at least portions of one or more patterns of the set of via patterns 242. In some embodiments, the second set of via patterns of method 1300 includes one or more via patterns similar to at least the set of vias 342. In some embodiments, the second set of via patterns of method 1300 includes one or more patterns or similar vias in the V0 layer.

In operation 1318 of method 1300, a third set of conductive feature patterns is generated or placed on the layout design. In some embodiments, the third set of conductive feature patterns of method 1300 includes at least portions of one or more patterns of at least the set of conductive feature patterns 240. In some embodiments, the third set of conductive feature patterns of method 1300 includes one or more conductive feature patterns similar to at least the set of conductors 340. In some embodiments, the third set of conductive feature patterns of method 1300 includes one or more patterns or similar conductors in the M1 layer.

In operation 1320 of method 1300, a third set of via patterns is generated or placed on the layout design. In some embodiments, the third set of via patterns of method 1300 includes at least portions of one or more patterns of the set of via patterns 252. In some embodiments, the third set of via patterns of method 1300 includes one or more via patterns similar to at least the set of vias 352. In some embodiments, the third set of via patterns of method 1300 includes one or more patterns or similar vias in the V1 layer.

In operation 1322 of method 1300, a fourth set of conductive feature patterns is generated or placed on the layout design. In some embodiments, the fourth set of conductive feature patterns of method 1300 includes at least portions of one or more patterns of at least the set of conductive feature patterns 250. In some embodiments, the fourth set of conductive feature patterns of method 1300 includes one or more conductive feature patterns similar to at least the set of conductors 350. In some embodiments, the fourth set of conductive feature patterns of method 1300 includes one or more patterns or similar conductors in the M2 layer.

In operation 1324 of method 1300, a fourth set of via patterns is generated or placed on the layout design. In some embodiments, the fourth set of via patterns of method 1300 includes at least portions of one or more patterns of the set of via patterns 262. In some embodiments, the fourth set of via patterns of method 1300 includes one or more via patterns similar to at least the set of vias 362. In some embodiments, the fourth set of via patterns of method 1300 includes one or more patterns or similar vias in the V2 layer.

In operation 1326 of method 1300, a fifth set of conductive feature patterns is generated or placed on the layout design. In some embodiments, the fifth set of conductive feature patterns of method 1300 includes at least portions of one or more patterns of at least the set of conductive feature patterns 260. In some embodiments, the fifth set of conductive feature patterns of method 1300 includes one or more conductive feature patterns similar to at least the set of conductors 360. In some embodiments, the fifth set of conductive feature patterns of method 1300 includes one or more patterns or similar conductors in the M3 layer.

FIG. 14 is a schematic view of a system 1400 for designing an IC layout design and manufacturing an IC circuit, in accordance with some embodiments.

In some embodiments, system 1400 generates or places one or more IC layout designs described herein. System 1400 includes a hardware processor 1402 and a non-transitory, computer readable storage medium 1404 (e.g., memory 1404) encoded with, i.e., storing, the computer program code 1406, i.e., a set of executable instructions 1406. Computer readable storage medium 1404 is configured for interfacing with manufacturing machines for producing the integrated circuit. The processor 1402 is electrically coupled to the computer readable storage medium 1404 by a bus 1408. The processor 1402 is also electrically coupled to an I/O interface 1410 by bus 1408. A network interface 1412 is also electrically connected to the processor 1402 via bus 1408. Network interface 1412 is connected to a network 1414, so that processor 1402 and computer readable storage medium 1404 are capable of connecting to external elements by network 1414. The processor 1402 is configured to execute the computer program code 1406 (e.g., non-transitory instructions) encoded in the computer readable storage medium 1404 in order to cause system 1400 to be usable for performing a portion or all of the operations as described in method 1200-1300.

In some embodiments, the processor 1402 is a central processing unit (CPU), a multi-processor, a distributed processing system, an application specific integrated circuit (ASIC), and/or a suitable processing unit.

In some embodiments, the computer readable storage medium 1404 is an electronic, magnetic, optical, electromagnetic, infrared, and/or a semiconductor system (or apparatus or device). For example, the computer readable storage medium 1404 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1404 includes a compact disk-read only memory (CD-ROM), a compact disk-read/write (CD-R/W), and/or a digital video disc (DVD).

In some embodiments, the storage medium 1404 stores the computer program code 1406 configured to cause system 1400 to perform method 1200-1300. In some embodiments, the storage medium 1404 also stores information needed for performing method 1200-1300 as well as information generated during performing method 1200-1300, such as layout design 1416, user interface 1418 and fabrication unit 1420, and/or a set of executable instructions to perform the operation of method 1200-1300. In some embodiments, layout design 1416 comprises one or more of layout patterns of at layout design 100A, 100B or 200, or features similar to at least integrated circuit 300, 400, 500, 600, 700, 800, 900 or 1000.

In some embodiments, the storage medium 1404 stores instructions (e.g., computer program code 1406) for interfacing with manufacturing machines. The instructions (e.g., computer program code 1406) enable processor 1402 to generate manufacturing instructions readable by the manufacturing machines to effectively implement method 1200-1300 during a manufacturing process.

System 1400 includes I/O interface 1410. I/O interface 1410 is coupled to external circuitry. In some embodiments, I/O interface 1410 includes a keyboard, keypad, mouse, trackball, trackpad, and/or cursor direction keys for communicating information and commands to processor 1402.

System 1400 also includes network interface 1412 coupled to the processor 1402. Network interface 1412 allows system 1400 to communicate with network 1414, to which one or more other computer systems are connected. Network interface 1412 includes wireless network interfaces such as BLUETOOTH, WIFI, WIMAX, GPRS, or WCDMA; or wired network interface such as ETHERNET, USB, or IEEE-2094. In some embodiments, method 1200-1300 is implemented in two or more systems 1400, and information such as layout design, and user interface are exchanged between different systems 1400 by network 1414.

System 1400 is configured to receive information related to a layout design through I/O interface 1410 or network interface 1412. The information is transferred to processor 1402 by bus 1408 to determine a layout design for producing at least integrated circuit 300, 400, 500, 600, 700, 800, 900 or 1000. The layout design is then stored in computer readable medium 1404 as layout design 1416. System 1400 is configured to receive information related to a user interface through I/O interface 1410 or network interface 1412. The information is stored in computer readable medium 1404 as user interface 1418. System 1400 is configured to receive information related to a fabrication unit 1420 through I/O interface 1410 or network interface 1412. The information is stored in computer readable medium 1404 as fabrication unit 1420. In some embodiments, the fabrication unit 1420 includes fabrication information utilized by system 1400. In some embodiments, the fabrication unit 1420 corresponds to mask fabrication 1534 of FIG. 15.

In some embodiments, method 1200-1300 is implemented as a standalone software application for execution by a processor. In some embodiments, method 1200-1300 is implemented as a software application that is a part of an additional software application. In some embodiments, method 1200-1300 is implemented as a plug-in to a software application. In some embodiments, method 1200-1300 is implemented as a software application that is a portion of an EDA tool. In some embodiments, method 1200-1300 is implemented as a software application that is used by an EDA tool. In some embodiments, the EDA tool is used to generate a layout of the integrated circuit device. In some embodiments, the layout is stored on a non-transitory computer readable medium. In some embodiments, the layout is generated using a tool such as VIRTUOSO® available from CADENCE DESIGN SYSTEMS, Inc., or another suitable layout generating tool. In some embodiments, the layout is generated based on a netlist which is created based on the schematic design. In some embodiments, method 1200-1300 is implemented by a manufacturing device to manufacture an integrated circuit using a set of masks manufactured based on one or more layout designs generated by system 1400. In some embodiments, system 1400 is a manufacturing device configured to manufacture an integrated circuit using a set of masks manufactured based on one or more layout designs of the present disclosure. In some embodiments, system 1400 of FIG. 14 generates layout designs of an integrated circuit that are smaller than other approaches. In some embodiments, system 1400 of FIG. 14 generates layout designs of integrated circuit structure that occupy less area and provide better routing resources than other approaches.

FIG. 15 is a block diagram of an integrated circuit (IC) manufacturing system 1500, and an IC manufacturing flow associated therewith, in accordance with at least one embodiment of the present disclosure. In some embodiments, based on a layout diagram, at least one of (A) one or more semiconductor masks or (B) at least one component in a layer of a semiconductor integrated circuit is fabricated using manufacturing system 1500.

In FIG. 15, IC manufacturing system 1500 (hereinafter “system 1500”) includes entities, such as a design house 1520, a mask house 1530, and an IC manufacturer/fabricator (“fab”) 1540, that interact with one another in the design, development, and manufacturing cycles and/or services related to manufacturing an IC device 1560. The entities in system 1500 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, one or more of design house 1520, mask house 1530, and IC fab 1540 is owned by a single larger company. In some embodiments, one or more of design house 1520, mask house 1530, and IC fab 1540 coexist in a common facility and use common resources.

Design house (or design team) 1520 generates an IC design layout 1522. IC design layout 1522 includes various geometrical patterns designed for an IC device 1560. The geometrical patterns correspond to patterns of metal, oxide, or semiconductor layers that make up the various components of IC device 1560 to be fabricated. The various layers combine to form various IC features. For example, a portion of IC design layout 1522 includes various IC features, such as an active region, gate electrode, source electrode and drain electrode, metal lines or vias of an interlayer interconnection, and openings for bonding pads, to be formed in a semiconductor substrate (such as a silicon wafer) and various material layers disposed on the semiconductor substrate. Design house 1520 implements a proper design procedure to form IC design layout 1522. The design procedure includes one or more of logic design, physical design or place and route. IC design layout 1522 is presented in one or more data files having information of the geometrical patterns. For example, IC design layout 1522 can be expressed in a GDSII file format or DFII file format.

Mask house 1530 includes data preparation 1532 and mask fabrication 1534. Mask house 1530 uses IC design layout 1522 to manufacture one or more masks 1545 to be used for fabricating the various layers of IC device 1560 according to IC design layout 1522. Mask house 1530 performs mask data preparation 1532, where IC design layout 1522 is translated into a representative data file (RDF). Mask data preparation 1532 provides the RDF to mask fabrication 1534. Mask fabrication 1534 includes a mask writer. A mask writer converts the RDF to an image on a substrate, such as a mask (reticle) 1545 or a semiconductor wafer 1542. The IC design layout 1522 is manipulated by mask data preparation 1532 to comply with particular characteristics of the mask writer and/or requirements of IC fab 1540. In FIG. 15, mask data preparation 1532 and mask fabrication 1534 are illustrated as separate elements. In some embodiments, mask data preparation 1532 and mask fabrication 1534 can be collectively referred to as mask data preparation.

In some embodiments, mask data preparation 1532 includes optical proximity correction (OPC) which uses lithography enhancement techniques to compensate for image errors, such as those that can arise from diffraction, interference, other process effects and the like. OPC adjusts IC design layout 1522. In some embodiments, mask data preparation 1532 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1532 includes a mask rule checker (MRC) that checks the IC design layout that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout to compensate for limitations during mask fabrication 1534, which may undo part of the modifications performed by OPC in order to meet mask creation rules.

In some embodiments, mask data preparation 1532 includes lithography process checking (LPC) that simulates processing that will be implemented by IC fab 1540 to fabricate IC device 1560. LPC simulates this processing based on IC design layout 1522 to create a simulated manufactured device, such as IC device 1560. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (DOF), mask error enhancement factor (MEEF), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout 1522.

It should be understood that the above description of mask data preparation 1532 has been simplified for the purposes of clarity. In some embodiments, data preparation 1532 includes additional features such as a logic operation (LOP) to modify the IC design layout according to manufacturing rules. Additionally, the processes applied to IC design layout 1522 during data preparation 1532 may be executed in a variety of different orders.

After mask data preparation 1532 and during mask fabrication 1534, a mask 1545 or a group of masks 1545 are fabricated based on the modified IC design layout 1522. In some embodiments, mask fabrication 1534 includes performing one or more lithographic exposures based on IC design layout 1522. In some embodiments, an electron-beam (e-beam) or a mechanism of multiple e-beams is used to form a pattern on a mask (photomask or reticle) 1545 based on the modified IC design layout 1522. The mask 1545 can be formed in various technologies. In some embodiments, the mask 1545 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary version of mask 1545 includes a transparent substrate (e.g., fused quartz) and an opaque material (e.g., chromium) coated in the opaque regions of the binary mask. In another example, the mask 1545 is formed using a phase shift technology. In the phase shift mask (PSM) version of mask 1545, various features in the pattern formed on the mask are configured to have proper phase difference to enhance the resolution and imaging quality. In various examples, the phase shift mask can be attenuated PSM or alternating PSM. The mask(s) generated by mask fabrication 1534 is used in a variety of processes. For example, such a mask(s) is used in an ion implantation process to form various doped regions in the semiconductor wafer, in an etching process to form various etching regions in the semiconductor wafer, and/or in other suitable processes.

IC fab 1540 is an IC fabrication entity that includes one or more manufacturing facilities for the fabrication of a variety of different IC products. In some embodiments, IC Fab 1540 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry entity.

IC fab 1540 includes wafer fabrication tools 1552 (hereinafter “fabrication tools 1552”) configured to execute various manufacturing operations on semiconductor wafer 1542 such that IC device 1560 is fabricated in accordance with the mask(s), e.g., mask 1545. In various embodiments, fabrication tools 1552 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1540 uses mask(s) 1545 fabricated by mask house 1530 to fabricate IC device 1560. Thus, IC fab 1540 at least indirectly uses IC design layout 1522 to fabricate IC device 1560. In some embodiments, a semiconductor wafer 1542 is fabricated by IC fab 1540 using mask(s) 1545 to form IC device 1560. In some embodiments, the IC fabrication includes performing one or more lithographic exposures based at least indirectly on IC design layout 1522. Semiconductor wafer 1542 includes a silicon substrate or other proper substrate having material layers formed thereon. Semiconductor wafer 1542 further includes one or more of various doped regions, dielectric features, multilevel interconnects, and the like (formed at subsequent manufacturing steps).

System 1500 is shown as having design house 1520, mask house 1530 or IC fab 1540 as separate components or entities. However, it is understood that one or more of design house 1520, mask house 1530 or IC fab 1540 are part of the same component or entity.

One aspect of this description relates to an integrated circuit. In some embodiments, the integrated circuit includes a first cell region including at least a first set of transistors, the first cell region extending in a first direction and having a first height in a second direction different from the first direction. In some embodiments, the first set of transistors include a first active region extending in the first direction, and being on a first level. In some embodiments, the integrated circuit further includes a second cell region including at least a second set of transistors, the second cell region extending in the first direction and having the first height in the second direction. In some embodiments, the second set of transistors include a second active region extending in the first direction, being on the first level, and being separated from the first active region in the second direction. In some embodiments, the integrated circuit further includes a first set of conductors extending in the first direction, being on a first metal layer above a front-side of a substrate, overlapping the first active region or the second active region, and being coupled to at least the first set of transistors or the second set of transistors, the first set of conductors configured to supply at least a supply voltage or a reference supply voltage. In some embodiments, the integrated circuit further includes a second set of conductors extending in the first direction, being on a second metal layer below a back-side of the substrate, being coupled to at least the first set of transistors, the second set of conductors configured to supply at least the supply voltage or the reference supply voltage. In some embodiments, the first set of transistors have a first size, and the second set of transistors have a second size different from the first size.

Another aspect of this description relates to an integrated circuit. In some embodiments, the integrated circuit includes a first set of transistors in a first region, the first region extending in a first direction and having a first height in a second direction different from the first direction. In some embodiments, the first set of transistors includes a first active region extending in the first direction, and being on a first level. In some embodiments, the integrated circuit further includes a second set of transistors in a second region, the second region extending in the first direction and having a second height in the second direction, the second height being different from the first height. In some embodiments, the second set of transistors includes a second active region extending in the first direction, being on the first level, and being separated from the first active region in the second direction. In some embodiments, the integrated circuit further includes a first set of conductors extending in the first direction, being on a first metal layer above a front-side of a substrate, overlapping the first active region, and being coupled to at least the first set of transistors, the first set of conductors configured to supply at least a supply voltage or a reference supply voltage, each conductor of the first set of conductors being separated from each other by a first pitch in the second direction. In some embodiments, the integrated circuit further includes a second set of conductors extending in the first direction, being on the first metal layer, being coupled to at least the second set of transistors, the second set of conductors configured to supply at least the supply voltage or the reference supply voltage, each conductor of the second set of conductors being separated from each other by a second pitch in the second direction, the second pitch being different from the first pitch, the second set of conductors being separated from the first set of conductors in the second direction. In some embodiments, the first set of transistors have a first size, and the second set of transistors have a second size different from the first size.

Yet another aspect of this description relates to a method of forming an integrated circuit. In some embodiments, the method includes fabricating a first set of transistors in a front-side of a substrate in a first row, the first row extending in a first direction, the first set of transistors including at least a first transistor, the first set of transistors having a first size. In some embodiments, the method further includes fabricating a second set of transistors in the front-side of the substrate in a second row, the second row extending in the first direction, and being separated from the first row in a second direction different from the first direction, the second set of transistors including a second transistor, the second set of transistors having a second size different from the first size. In some embodiments, the method further includes electrically coupling a first set of conductors on the front-side of the substrate to at least the first set of transistors or the second set of transistors. In some embodiments, electrically coupling the first set of conductors on the front-side of the substrate to at least the first set of transistors or the second set of transistors includes depositing a first conductive material on the front-side of the substrate on a first metal level thereby forming the first set of conductors, the first set of conductors being electrically coupled to at least the first set of transistors or the second set of transistors. In some embodiments, the method further includes electrically coupling a second set of conductors on a back-side of the substrate to at least the first set of transistors. In some embodiments, electrically coupling the second set of conductors on the back-side of the substrate to at least the first set of transistors includes depositing a second conductive material on the back-side of a thinned substrate on a second metal level thereby forming the second set of conductors, the second set of conductors being electrically coupled to at least the first set of transistors.

A number of embodiments have been described. It will nevertheless be understood that various modifications may be made without departing from the spirit and scope of the disclosure. For example, various transistors being shown as a particular dopant type (e.g., N-type or P-type Metal Oxide Semiconductor (NMOS or PMOS)) are for illustration purposes. Embodiments of the disclosure are not limited to a particular type. Selecting different dopant types for a particular transistor is within the scope of various embodiments. The low or high logical value of various signals used in the above description is also for illustration. Various embodiments are not limited to a particular logical value when a signal is activated and/or deactivated. Selecting different logical values is within the scope of various embodiments. In various embodiments, a transistor functions as a switch. A switching circuit used in place of a transistor is within the scope of various embodiments. In various embodiments, a source of a transistor can be configured as a drain, and a drain can be configured as a source. As such, the term source and drain are used interchangeably. Various signals are generated by corresponding circuits, but, for simplicity, the circuits are not shown.

Various figures show capacitive circuits using discrete capacitors for illustration. Equivalent circuitry may be used. For example, a capacitive device, circuitry or network (e.g., a combination of capacitors, capacitive elements, devices, circuitry, or the like) can be used in place of the discrete capacitor. The above illustrations include exemplary operations or steps, but the steps are not necessarily performed in the order shown. Steps may be added, replaced, changed order, and/or eliminated as appropriate, in accordance with the spirit and scope of disclosed embodiments.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated circuit, comprising:
a first cell region including at least a first set of transistors, the first cell region extending in a first direction and having a first height in a second direction different from the first direction, the first set of transistors comprising:
a first active region extending in the first direction, and being on a first level;
a second cell region including at least a second set of transistors, the second cell region extending in the first direction and having the first height in the second direction, the second set of transistors comprising:
a second active region extending in the first direction, being on the first level, and being separated from the first active region in the second direction;
a first set of conductors extending in the first direction, being on a first metal layer above a front-side of a substrate, overlapping the first active region or the second active region, and being coupled to at least the first set of transistors or the second set of transistors, the first set of conductors configured to supply at least a supply voltage or a reference supply voltage; and
a second set of conductors extending in the first direction, being on a second metal layer below a back-side of the substrate, being coupled to at least the first set of transistors, the second set of conductors configured to supply at least the supply voltage or the reference supply voltage;
wherein the first set of transistors have a first size, and the second set of transistors have a second size different from the first size.

2. The integrated circuit of claim 1, wherein the first set of transistors comprises:
a first transistor; and
a first contact extending in the second direction, overlapping the first active region, and being on a third metal layer different from the first metal layer and the second metal layer, the first contact being electrically coupled to a first source of the first transistor.

3. The integrated circuit of claim 2, wherein the first set of transistors further comprises:
a second contact extending in the second direction, being overlapped by the first active region, and being on a fourth metal layer different from the first metal layer, the second metal layer and the third metal layer, the second contact being electrically coupled to the first source of the first transistor.

4. The integrated circuit of claim 3, wherein the second set of transistors comprises:
a second transistor; and
a third contact extending in the second direction, overlapping the second active region, and being on the third metal layer, the third contact being electrically coupled to a first source of the second transistor.

5. The integrated circuit of claim 1, wherein
the first active region has a first width in the second direction, the first width being the first size; and
the second active region has a second width in the second direction, the second width being the second size, and being different from the first width.

6. The integrated circuit of claim 1, further comprising:
a first via between a first conductor of the first set of conductors and a first conductor of the second set of conductors, the first via being next to the second cell region.

7. The integrated circuit of claim 6, further comprising:
a second via between the first conductor of the first set of conductors and the first conductor of the second set of conductors, the second via being next to the first via, and the first via being between the second via and the second cell region.

8. The integrated circuit of claim 1, further comprising:
a first conductor extending in the second direction, being on a third metal layer above the front-side of the substrate, the third metal layer being different from the first metal layer and the second metal layer, the first conductor overlapping the first set of conductors and the second set of conductors; and
a first via between the first conductor and a first conductor of the first set of conductors, the first via electrically coupling the first conductor and the first conductor of the first set of conductors together.

9. The integrated circuit of claim 8, further comprising:
a second conductor extending in the first direction, being on a fourth metal layer above the front-side of the substrate, the fourth metal layer being different from the first metal layer, the second metal layer and the third metal layer, the second conductor overlapping the first conductor, the first set of conductors and the second set of conductors; and
a second via between the second conductor and the first conductor, the second via electrically coupling the second conductor and the first conductor together.

10. The integrated circuit of claim 9, further comprising:
a third conductor extending in the second direction, being on a fifth metal layer above the front-side of the substrate, the fifth metal layer being different from the first metal layer, the second metal layer, the third metal layer and the fourth metal layer, the third conductor overlapping the first conductor, the second conductor, the first set of conductors and the second set of conductors; and
a third via between the third conductor and the second conductor, the third via electrically coupling the third conductor and the second conductor together.

11. An integrated circuit, comprising:
a first set of transistors in a first region, the first region extending in a first direction and having a first height in a second direction different from the first direction, the first set of transistors comprising:
a first active region extending in the first direction, and being on a first level;
a second set of transistors in a second region, the second region extending in the first direction and having a second height in the second direction, the second height being different from the first height, the second set of transistors comprising:
a second active region extending in the first direction, being on the first level, and being separated from the first active region in the second direction;
a first set of conductors extending in the first direction, being on a first metal layer above a front-side of a substrate, overlapping the first active region, and being coupled to at least the first set of transistors, the first set of conductors configured to supply at least a supply voltage or a reference supply voltage, each conductor of the first set of conductors being separated from each other by a first pitch in the second direction; and
a second set of conductors extending in the first direction, being on the first metal layer, being coupled to at least the second set of transistors, the second set of conductors configured to supply at least the supply voltage or the reference supply voltage, each conductor of the second set of conductors being separated from each other by a second pitch in the second direction, the second pitch being different from the first pitch, the second set of conductors being separated from the first set of conductors in the second direction,
wherein the first set of transistors have a first size, and the second set of transistors have a second size different from the first size.

12. The integrated circuit of claim 11, further comprising:
a third set of conductors extending in the first direction, being on a second metal layer below a back-side of the substrate, being coupled to at least the first set of transistors, the second set of conductors configured to supply at least the supply voltage or the reference supply voltage, each conductor of the third set of conductors being separated from each other by the first pitch in the second direction; and
a fourth set of conductors extending in the first direction, being on the second metal layer, being coupled to at least the second set of transistors, the fourth set of conductors configured to supply at least the supply voltage or the reference supply voltage, each conductor of the fourth set of conductors being separated from each other by the second pitch in the second direction, the fourth set of conductors being separated from the third set of conductors in the second direction.

13. The integrated circuit of claim 12, further comprising:
a first via between a first conductor of the second set of conductors and a first conductor of the fourth set of conductors, the first via being next to the second region, and electrically coupling the first conductor of the second set of conductors and the first conductor of the fourth set of conductors together.

14. The integrated circuit of claim 13, further comprising:
a second via between the first conductor of the second set of conductors and the first conductor of the fourth set of conductors, the second via being next to the first via, and electrically coupling the first conductor of the second set of conductors and the first conductor of the fourth set of conductors together, and the first via being between the second via and the second region.

15. The integrated circuit of claim 12, wherein the first set of transistors comprises:
a first transistor; and
a first contact extending in the second direction, overlapping the first active region, and being on a third metal layer different from the first metal layer and the second metal layer, the first contact being electrically coupled to a first source of the first transistor.

16. The integrated circuit of claim 15, wherein the first set of transistors further comprises:
a second contact extending in the second direction, being overlapped by the first active region, and being on a fourth metal layer different from the first metal layer, the second metal layer and the third metal layer, the second contact being electrically coupled to the first source of the first transistor.

17. The integrated circuit of claim 16, wherein the second set of transistors comprises:
a second transistor; and
a third contact extending in the second direction, overlapping the second active region, and being on the third metal layer, the third contact being electrically coupled to a first source of the second transistor.

18. The integrated circuit of claim 12, wherein
the first active region has a first width in the second direction, the first width being the first size; and
the second active region has a second width in the second direction, the second width being the second size, and being different from the first width.

19. The integrated circuit of claim 12, further comprising:
a first conductor extending in the second direction, being on a third metal layer above the front-side of the substrate, the third metal layer being different from the first metal layer and the second metal layer, the first conductor overlapping the first set of conductors and the second set of conductors; and
a first via between the first conductor and a first conductor of the first set of conductors, the first via electrically coupling the first conductor and the first conductor of the first set of conductors together.

20. A method of forming an integrated circuit, the method comprising:
fabricating a first set of transistors in a front-side of a substrate in a first row, the first row extending in a first direction, the first set of transistors including at least a first transistor, the first set of transistors having a first size;
fabricating a second set of transistors in the front-side of the substrate in a second row, the second row extending in the first direction, and being separated from the first row in a second direction different from the first direction, the second set of transistors including a second transistor, the second set of transistors having a second size different from the first size;
electrically coupling a first set of conductors on the front-side of the substrate to at least the first set of transistors or the second set of transistors, wherein electrically coupling the first set of conductors on the front-side of the substrate to at least the first set of transistors or the second set of transistors comprises:
depositing a first conductive material on the front-side of the substrate on a first metal level thereby forming the first set of conductors, the first set of conductors being electrically coupled to at least the first set of transistors or the second set of transistors; and
electrically coupling a second set of conductors on a back-side of the substrate to at least the first set of transistors, wherein electrically coupling the second set of conductors on the back-side of the substrate to at least the first set of transistors comprises:
depositing a second conductive material on the back-side of a thinned substrate on a second metal level thereby forming the second set of conductors, the second set of conductors being electrically coupled to at least the first set of transistors.
